(19) United States
(12) Patent Application Publication
(10) Pub. No.: US 2026/0254683 A1
(43) Pub. Date: Aug. 27, 2026

(54) METHOD FOR SELECTING SYMBOLS AND DATA COMMUNICATION SYSTEM USING THE SELECTED SYMBOLS

(71) Applicants: Sang-Hyun HAN, Anyang-si (KR); LEADING UI CO., LTD., Anyang-si (KR)

(72) Inventors: Sang-Hyun HAN, Anyang-si (KR); Seung-Hee HAN, Anyang-si (KR)

(73) Assignees: Sang-Hyun HAN, Anyang-si (KR); LEADING UI CO., LTD., Anyang-si (KR)

(21) Appl. No.: 19/254,113

(22) Filed: Jun. 30, 2025

(30) Foreign Application Priority Data
Feb. 21, 2025 (KR) 10-2025-0022667
Jun. 16, 2025 (KR) 10-2025-0078549

(51) Int. Cl. H04L 25/49; H04L 25/02

(52) U.S. Cl. CPC H04L 25/4917; H04L 25/026; H04L 25/0272

(57) ABSTRACT

A data communication system includes a link unit, a first communication unit, and a second communication unit. The first communication unit is connected to the link unit to transmit and receive pulse amplitude modulation (PAM) signals. The second communication unit is connected to the link unit to transmit and receive the PAM signals. The number of PAM signal levels is greater than or equal to the number of transmission lines, the sum of PAM values of each transmission line is “0”, and signal pairs with different signal levels of each transmission line are assigned to a vertex and a line segment of an inference graph diagram using graph coloring theory, and are defined as symbols according to a determined relationship. Each of the first communication unit and the second communication unit encodes and transmits transmission data to fit a corresponding symbol, and decodes and restores the received data.

### CROSS-REFERENCE TO RELATED APPLICATIONS

This application claims priority under 35 U.S.C. § 119 to Korean Patent Application No. 10-2025-0022667, filed on Feb. 21, 2025, and Korean Patent Application No. 10-2025-0078549, filed on Jun. 16, 2025 in the Korean Intellectual Property Office (KIPO), the contents of which are herein incorporated by reference in their entirety.

### BACKGROUND OF THE INVENTION

### Technical Field

Exemplary embodiments of the present invention relate to a method for selecting symbols and a data communication system using the selected symbols. More particularly, exemplary embodiments of the present invention relate to a method for selecting symbols, which are PAM signal pairs for expressing electrical signals on each transmission line using the principle of graph coloring algorithms, and a data communication system using the selected symbols.

### Discussion of the Related Art

The most problematic thing in high-speed communication by wire is the parasitic capacitance present between the transmission line and the ground signal and the matching capacitance value present between the transmission lines. The inductance component and the resistance component of the transmission line also affect the high-speed communication of the wire, but due to the development of high-speed transmission line manufacturing technology, the inductance component and the resistance component are relatively negligible. Since the signal is transmitted using the amount of change in voltage appearing on the high-speed transmission line, the capacitance value of the transmission line increases the time constant and the capacitive load, making it difficult to transmit high-speed data or communicate data between long lines (long-distance data communication).

In general, when a signal voltage having a pulse period or phase information is applied, a line capacitance is an element that interferes with communication by generating effects such as distortion and attenuation of a signal, a phase delay, and the like.

Wired high-speed serial communication techniques such as MIPI, LVDS, USB2.0, USB3.0, SATA, etc., which have been known until recently, have increased the speed through high-speed serial signal transmission by reducing an amplitude of the signal voltage to reduce the effect of the capacitive load.

A current value ‘i’ required for signal transmission may be defined by i=C*(dv/dt). That is, as a frequency component dv/dt (that is, an amount of voltage fluctuation over time) increases, the amount of current ‘i’ required for signal transmission increases even though a value of C, which is the same capacitive load, is constant. In addition, impedance on the signal line also acts as a resistance, increasing the time constant, thereby interfering with high-speed signal transmission.

Meanwhile, due to the advent of big data applications such as artificial intelligence (AI), virtual reality, and media streaming, the amount of data computed and transmitted is increasing significantly. The energy cost of DRAM access in computing systems is increasing as system performance is advanced.

### SUMMARY

Exemplary embodiments of the present invention provide a method for selecting symbols, which are PAM signal pairs for expressing electrical signals in each transmission line, by utilizing the principle of a graph coloring algorithm for parallel data communication using a pulse amplitude modulation (PAM) signal.

Exemplary embodiments of the present invention provide a data communication system capable of high-speed parallel data transmission with stable data transmission/reception and high data transmission rates using the symbol selected through the symbol selection method.

According to one aspect of the present invention, there is provided a method of selecting a symbol. In the method, a first condition, a second condition, a third condition, and a fourth condition are inputted to be identified in a program designed to select a symbol. Here, the first condition is that the sum of the difference values based on the common voltage of all transmission lines equals 0V, and the second condition is that adjacent transmission lines must have different signal levels. The third condition is that the elements must convert into differential signals through a comparison of signal levels between adjacent transmission lines and must have different differential signals, and the fourth condition is that the elements must convert into differential signals through a comparison of signal levels between non-adjacent transmission lines and must have different differential signals. Then, the number of transmission lines, the number of signal levels, and determining the type of signal levels are inputted. Then, a candidate list and a resultant list are initialized. Then, the number of transmission lines, the number of signal levels, and the number of all possible configurations of the transmission lines are inputted into the candidate list, taking into account the types of signal levels. Then, one element is extracted from the candidate list. Then, the extracted element is inputted into the resultant list when the extracted element satisfies the first condition and then repeating the extracting one element. Then, the extracted element is inputted into the resultant list when the extracted element satisfies the second condition and then repeating the extracting one element. Then, the extracted element is inputted into the resultant list when the extracted element satisfies the third condition and then repeating the extracting one element. Then, the extracted element is inputted into the resultant list when the extracted element satisfies the fourth condition and then repeating the extracting one element. Then, the resultant list is outputted when there are no remaining elements in the candidate list.

In an exemplary embodiment of the present invention, the element may mean each of the number of cases according to the number of transmission lines and the number of signal levels.

According to another aspect of the present invention, a data communication system includes a link unit, a first communication unit, and a second communication unit. The link unit includes a plurality of transmission lines. The first communication unit is connected to one side of the link unit to transmit and receive pulse amplitude modulation (PAM) signals. The second communication unit is connected to another side of the link unit to transmit and receive the PAM signals. The number of PAM signal levels driving the transmission line is greater than or equal to the number of transmission lines, the sum of PAM values of each transmission line is “0”, and signal pairs with different signal levels of each transmission line are assigned to a vertex and a line segment of an inference graph diagram using graph coloring theory, and are defined as symbols according to a determined relationship. Each of the first communication unit and the second communication unit encodes and transmits transmission data to fit a corresponding symbol, and decodes and restores the received data.

In an exemplary embodiment of the present invention, each of the first communication unit and the second communication unit may include a PHY unit and an encoding/decoding unit. The PHY unit includes one or more DRV blocks converting a voltage-level TX signal input from an external side into current and output the converted current to the transmission line through an I/O pad, and one or more RCV blocks receiving PAM signals transmitted through the link unit. The PHY unit is connected to one side of the link unit to transmit and receive the PAM signal. The encoding/decoding unit is connected to another side of the PHY unit.

In an exemplary embodiment of the present invention, the DRV block may include a first TX buffer buffering the first TX signal, a first TX resistor having one end connected to an output terminal of the first TX buffer and another end connected to the I/O pad, a second TX buffer buffering the second TX signal, and a second TX resistor having one end connected to an output terminal of the second TX buffer and another end connected to the I/O pad.

In an exemplary embodiment of the present invention, the DRV block may include a PAM encoding unit, a first buffer, and a voltage-to-current converter. The PAM encoding unit encoding the TX signal according to the TX enable signal. The first buffer includes a front-end inverter inverting the TX signal when enabled by the TX enable signal, and a rear-end inverter connected to the output of the front-end inverter, which inverts the signal inverted by the front-end inverter when enabled by the TX enable signal. The voltage-to-current converter converts the PAM signal buffered by the first buffer into current.

In an exemplary embodiment of the present invention, the DRV block may include a first TX buffer buffering a first TX signal, a first TX resistor having one end connected to the output side of the first TX buffer, a second TX buffer buffering a second TX signal, a second TX resistor having one end connected to the output side of the second TX buffer, and a current conveyor. The current conveyor include an X-port connected to the common node of the first TX resistor and the second TX resistor, a Y-port to which the common-mode voltage on the transmission line is applied, and a ZP-port connected to the I/O pad.

In an exemplary embodiment of the present invention, the DRV block may include a first TX buffer buffering a first TX signal, a first TX resistor having one end connected to the output side of the first TX buffer, a second TX buffer buffering a second TX signal, a second TX resistor having one end connected to the output side of the second TX buffer, a current conveyor, and a pre-emphasis circuit. The current conveyor includes an X-port connected to the common node of the first TX resistor and the second TX resistor, a Y-port to which the common-mode voltage on the transmission line is applied, and a ZP-port connected to the I/O pad. The pre-emphasis circuit includes a pre-emphasis buffer, a variable resistor, and a variable capacitor, and is enabled by a TX enable signal, wherein the pre-emphasis circuit temporarily increases or decreases the strength of the TX signal applied to the X-port of the current conveyor.

In an exemplary embodiment of the present invention, the RCV block may include a voltage generating part comprising a plurality of RC parallel circuits to convert the current of the PAM signal provided through the transmission line into a voltage, and a voltage comparator module comprising a plurality of differential voltage comparators, which differentially compare the PAM signals converted into voltage by the voltage generating part.

In an exemplary embodiment of the present invention, in each of the RC parallel circuits, the R value may be a value of the intended circuit component between 1002 and 30052, and the C value may be the value of an unintended parasitic capacitance component or an intended correction capacitance component.

In an exemplary embodiment of the present invention, each of the differential voltage comparators may include differential voltage comparators detecting the difference in the input voltage of the gate by applying a current bias.

In an exemplary embodiment of the present invention, the RCV block may include a voltage generating part and a voltage comparator module. The voltage generating part includes a plurality of current conveyors and a plurality of RC parallel circuits disposed at the output side of the current conveyors. The voltage generating part converts the current of the PAM signal provided through the transmission line into a voltage. The voltage comparator module includes a plurality of differential voltage comparators, which differentially compare the PAM signals converted into voltage by the voltage generating part.

In an exemplary embodiment of the present invention, the voltage comparator module may include a first differential voltage comparator, a second differential voltage comparator, a third differential voltage comparator, a fourth differential voltage comparator, a fifth differential voltage comparator, and a sixth differential voltage comparator. The first differential voltage comparator outputs a first differential voltage by differentially comparing a first voltage and a second voltage provided by the voltage generating part. The second differential voltage comparator outputs a second differential voltage by comparing the second voltage and a third voltage provided by the voltage generating part. The third differential voltage comparator outputs a third differential voltage by comparing the third voltage and a fourth voltage provided by the voltage generating part. The fourth differential voltage comparator outputs a fourth differential voltage by comparing the first voltage and the fourth voltage provided by the voltage generating part. The fifth differential voltage comparator outputs a fifth differential voltage by comparing the first voltage and the third voltage provided by the voltage generating part. The sixth differential voltage comparator outputs a sixth differential voltage by comparing the second voltage and the fourth voltage provided by the voltage generating part.

In an exemplary embodiment of the present invention, each of the first to sixth differential voltage comparators may operate in response to a clock.

In an exemplary embodiment of the present invention, each of the first to sixth differential voltage comparators may include a differential ARM (Analog Re-generative Memory) latch voltage comparator detecting the difference in the input voltage of the gate using a comparison clock.

In an exemplary embodiment of the present invention, the differential ARM (Analog Re-generative Memory) latch voltage comparator may include a differential voltage comparator and an SR latch. The differential voltage comparator compares two input signals and determines the output signal by amplifying the difference between VIN (+) and VIN (−), and generates the output signal based on the amplified difference. The SR latch stores the output state of the differential voltage comparator and maintains it for a predetermined time.

In an exemplary embodiment of the present invention, the RCV block may include a voltage generating part and a voltage comparator module. The voltage generating part includes a plurality of current conveyors and a plurality of R circuits arranged at the output side of the current conveyors, and converts the current of the PAM signal provided through the transmission line into a voltage. The voltage comparator module includes a plurality of differential voltage comparators, and differentially comparing the PAM signals converted into voltage by the voltage generating part.

In an exemplary embodiment of the present invention, the voltage generating part may further include a variable resistor having one end connected to the transmission line and another end connected to the current conveyor.

In an exemplary embodiment of the present invention, each of the first communication unit and the second communication unit may further include a pre-encoder that is connected to another side of the encoding/decoding unit on one side, receives data to be transmitted from a processor unit or memory device during signal transmission, and performs pre-encoding processing on the received data.

In an exemplary embodiment of the present invention, each of the first communication unit and the second communication unit may further include a post decoder that is connected to another side of the encoding/decoding unit on one side, and performs post-decoding processing on the data received during data reception.

According to the method for selecting symbols and the data communication system using the selected symbols, high-speed parallel data transmission can be realized with stable data transmission/reception and high data transmission rates by selecting symbols, which are PAM signal pairs for expressing each transmission line as electrical signals, using the selected symbols to generate data to be transmitted to the transmission line, and restoring the original data from the signals transmitted when receiving data.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a block diagram for schematically illustrating a data communication system according to the present invention;

FIG. 2 is a diagram for explaining a graph figure for inference using graph coloring theory when there are three transmission lines constituting a link unit;

FIG. 3 is a diagram for explaining a graph figure for inference using graph coloring theory when there are four transmission lines constituting a link unit;

FIG. 4 is a diagram for explaining a graph figure for inference using graph coloring theory when there are five transmission lines constituting a link unit;

FIG. 5 is a diagram for explaining a graph figure for inference using graph coloring theory when there are six transmission lines constituting a link unit;

FIG. 6 is a diagram for explaining a graph figure for inference using graph coloring theory when there are six transmission lines constituting a link unit;

FIG. 7A and FIG. 7B are flowcharts for explaining symbol selection according to the present invention;

FIG. 8 is an electrical equivalent modeling circuit for one transmission line shown in FIG. 1;

FIG. 9 is a circuit symbol for explaining a link unit with four transmission lines shown in FIG. 8;

FIG. 10 is a diagram for explaining the concept of configuring a link by the n link units shown in FIG. 9;

FIG. 11 is a block diagram for explaining a data communication system according to an embodiment of the present invention;

FIG. 12 is a diagram for explaining the first PHY unit, the link unit, and the second PHY unit shown in FIG. 11;

FIG. 13 is a circuit diagram for explaining an example of a DRV block shown in FIG. 12;

FIG. 14 is a circuit diagram for explaining another example of the DRV block shown in FIG. 12;

FIG. 15 is a circuit diagram for explaining another example of the DRV block shown in FIG. 12;

FIG. 16 is a circuit diagram for explaining an example of the current conveyor shown in FIG. 15;

FIG. 17 is a circuit diagram for explaining an example of the RCV block shown in FIG. 12;

FIG. 18 is a circuit diagram for explaining another example of the RCV block shown in FIG. 12;

FIG. 19 is a circuit diagram for explaining an example of a voltage comparator shown in FIG. 17 or FIG. 18;

FIG. 20 is a circuit diagram for explaining a first differential voltage comparator of the voltage comparator module shown in FIG. 19;

FIG. 21 is a circuit diagram for explaining an example of a voltage comparator module shown in FIG. 17 or FIG. 18;

FIG. 22 is a circuit diagram for explaining a first differential voltage comparator of the voltage comparator module shown in FIG. 21;

FIG. 23 is a circuit diagram for explaining another example of the DRV block shown in FIG. 12;

FIG. 24 is a circuit diagram for explaining another example of the current conveyor shown in FIG. 15;

FIG. 25 is a circuit diagram for explaining an example of the voltage generating part shown in FIG. 17;

FIG. 26 is a circuit diagram for explaining another example of the voltage generating part shown in FIG. 17;

FIG. 27 is a circuit diagram for explaining another example of the RCV block shown in FIG. 12;

FIG. 28 is a circuit diagram for explaining another example of the RCV block shown in FIG. 12;

FIG. 29A, FIG. 29B, and FIG. 29C are graphs showing a signal amplitude according to an output impedance of the X-port of the RCV block shown in FIG. 28;

FIG. 30A and FIG. 30B are circuit diagrams illustrating another example of the current comparator module shown in FIG. 17 or FIG. 18;

FIG. 31 is a circuit diagram for explaining a first differential current comparator of the current comparator module shown in FIG. 27 or FIG. 30;

FIG. 32 is a circuit diagram for explaining a first differential current comparator of the current comparator module shown in FIG. 27 or FIG. 30;

FIG. 33 illustrates an eye-diagram of the PAM4 signal received from the PAM4 signal basic communication system according to a comparative example;

FIG. 34 illustrates an eye-diagram of the PAM4 signal received from the PAM4 signal basic communication system according to the present invention;

FIG. 35 is a block diagram for explaining a first encoding/decoding unit shown in FIG. 11; and

FIG. 36 is a diagram for explaining symbol restoration by the first communication unit or the second communication unit shown in FIG. 11.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

The terms described in this present specification are defined as follows.

The term “Processor Unit” refers to an IC in charge of logical operations such as AI Processor, GPU, CPU, SoC, etc.

The term “processor module” refers to a board or assembly including an HBM and a processor unit.

The term “DDR RAM” includes DDR4, DDR5, DDR6, GDDR5, GDDR6, etc.

The term “TSV link” refers to a signal transmission line (data transmission line) connected by TSV between DRAM dies and interface dies within HBM.

The term “T-Link” refers to a silicon interposer between the processor unit and the HBM, or a signal transmission line (i.e., a data transmission line) connected by a PCB.

The term “physical layer (PHY)” refers to a layer that transmits and receives data in each bit unit as an electrical signal, and refers to a layer that transmits and receives an electrical signal to an actual data transmission line. The present invention relates to a configuration of a PHY unit and an encoder/decoder for transmitting and receiving data through the PHY unit.

The term “link unit” is defined by a plurality of transmission lines.

The term “communication link” is defined as a plurality of link units.

A unit of transmission line (e.g., link unit, T-link unit, TSV-link unit) refers to the minimum communication unit composed of PAM signals, and consists of three, four, five, or more transmission lines. A communication link is formed by extending the number of link units to N. The communication link may be implemented using various signal transmission media, such as T-links, TSV-links, PCB patterns, or wires.

The term “communication system” refers to a bidirectional communication system implemented with a first communication module (or first communication unit), a set of transmission lines (or link units), and a second communication module (or second communication unit).

The term “communication system module” refers to a configuration composed of at least two or more communication systems, wherein the number of communication systems is matched to the number of transmission lines, which is a multiple of four (4×N), such as 8, 16, 32, 64, 128, 256, . . . 1024, 2048.

The term “communication entity” refers to a semiconductor system that governs either side of a communication system or module comprising one or more components, and performs data transmission (i.e., transmission and reception), such as host and device or server and client roles. In the present embodiment, the communication entity may refer to a memory device and a processor unit in a structure where the memory device is connected to the processor unit. Alternatively, the communication entity may refer to both processor units in a structure where two processor units are interconnected.

The term “NRZ (Non-Return-to-Zero) signal” refers to a signal modulation scheme in which each 1-bit data value, “0” or “1,” is mapped to one of two distinct amplitude levels of an electrical signal. For example, if the NRZ signal corresponding to a 1-bit value is either 0V or 1V, the bit value 0 is simply converted to a 0V signal, and the bit value 1 is converted to a 1V signal.

The term “Pulse Amplitude Modulation (PAM) signal” refers to a method in which an encoding/decoding technique is applied to convert data into an electrical signal with at least three or more amplitude levels, corresponding to the meaning of two or more bits. For example, PAM4 represents a case where four signal levels are used per transmission line, encoding 2-bit data values (00, 01, 10, 11) into relative voltage levels such as (−3, −1, +1, +3), and transmitting the encoded signal through a single transmission line. Since PAM4 transmits 2-bit data over one transmission line, it enables twice the data throughput compared to the NRZ method for a given transmission line. In general, PAM has disadvantages such as higher power consumption, lower signal-to-noise ratio (SNR), and higher bit error ratio (BER) compared to NRZ. However, PAM is commonly used for high-speed data transmission through the application of advanced signal processing and error correction techniques.

“PAM4” refers to a signal modulation technique that uses four distinct signal levels for the transmission of high-speed signals. Compared to NRZ (Non-Return-to-Zero) signals, which utilize two signal levels (high and low) to represent digital logic values of 1 and 0, PAM4 signals employ two additional levels. An NRZ signal is capable of transmitting only one bit of information per symbol period. In contrast, PAM4 signals can transmit two bits of logical information per symbol period by using four different signal levels corresponding to (00, 01, 10, 11). Accordingly, PAM4 provides the advantage of doubling the bit rate for a given baud rate compared to NRZ.

The term “Bit Error Ratio (BER)” refers to an index used to evaluate the extent to which a digital signal is affected by analog characteristics such as noise and distortion in digital communication. It typically represents the ratio of the number of erroneous bits to the total number of transmitted bits.

The term “symbol” refers to the fundamental transmitting unit used to convey digital data in a communication system. A symbol is a signal unit represented by a specific state, waveform, frequency, phase, or amplitude on the transmission line. A symbol can represent one or multiple bits of information at a time. For example, in the case of PAM2, two symbols (representing 0 and 1) are used to transmit 1 bit per symbol. In PAM4, four symbols (representing 00, 01, 10, and 11) are used to transmit 2 bits per symbol. In PAM8, eight symbols (representing 000, 001, 010, 011, 100, 101, 110, and 111) are used to transmit 3 bits per symbol.

The term “encoding” refers to the process of converting data to be transmitted into specific signal symbols that carry physical meaning as electrical signals.

The term “decoding” refers to the process of recovering data from received signal symbols that carry physical meaning as electrical signals.

The term “graph coloring theory” refers to a method in graph theory of assigning colors to the vertices of a graph such that no two adjacent vertices share the same color. The graph coloring theory may be used to define invariants of a graph.

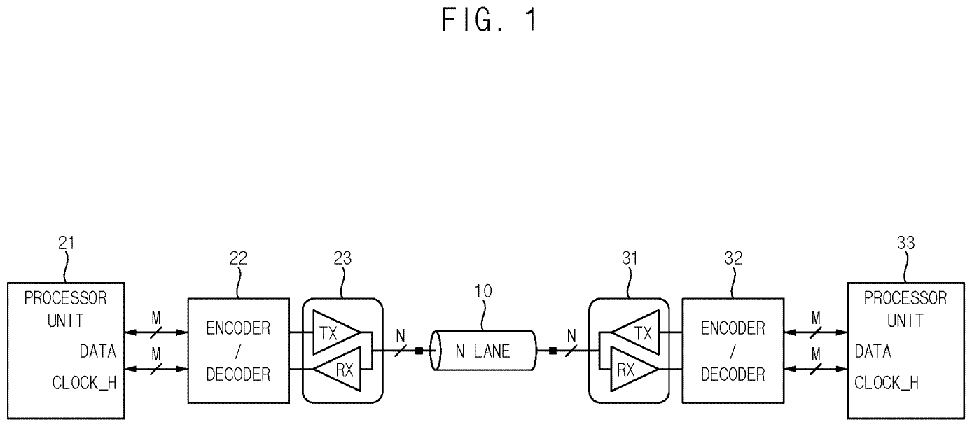

FIG. 1 is a block diagram for schematically illustrating a data communication system according to the present invention.

Referring to FIG. 1, a data communication system according to an embodiment of the present invention includes a transmission line 10, a first processor unit 21 disposed at one side of the transmission line 10, a first encoder/decoder 22 connected to an output terminal of the first processor unit 21, a first transmit/receive buffer 23 connected to an output terminal of the first encoder/decoder 22 and one side of the transmission line 10, a second transmit/receive buffer 31 connected to the opposite side of the transmission line 10, a second encoder/decoder 32 connected to an output terminal of the second transmit/receive buffer 31, and a second processor unit 33 connected to an output terminal of the second encoder/decoder 32.

In the present embodiment, the first processor unit 21, the first encoder/decoder 22, and the first transmit/receive buffer 23 may define a first chiplet, and the second transmit/receive buffer 31, the second encoder/decoder 32, and the second processor unit 33 may define a second chiplet. The first chiplet and the second chiplet refer to a complete chip formed by combining modular components in semiconductor design. Whereas conventional methods focused on designing a single large chip, chiplet technology involves combining multiple smaller chips (chiplets) to form a single system. Integration performance between chiplets can be enhanced by utilizing 2.5D and 3D packaging technologies. In other words, the chiplet system was developed to overcome the limitations of conventional monolithic chips, where dies within the package may be interconnected via a silicon interposer, and chiplets within the chiplet system may communicate with each other according to die-to-die communication standards such as UCIe (Universal Chiplet Interconnect express).

The present invention simplifies circuit configuration by transmitting and receiving data using symbols determined through encoding and decoding of parallel data as the data transmitting units, without employing a serializer/deserializer (SerDes) or a phase-locked loop (PLL).

In addition, the present invention improves the bit error ratio (BER) by determining the received values through comparison of differential values between transmission lines, and minimizes the number of comparators, thereby reducing silicon area and minimizing power consumption required for data transmission.

In addition, the present invention employs a method of directly converting parallel data into symbols for transmission through parallel transmission lines without overhead or data conversion between parallel and serial formats. Accordingly, it does not use temporary data storage flip-flops for data conversion required by a separate SerDes, and there is no time latency associated with the SerDes process.

Table 1 shows an example of some codes of 8B10B code conversion.

TABLE 1

| 8 B(Raw data) | | 10 B(SerDes conversion data) | | |
|---|---|---|---|---|
| Bit sequence: (MSB - - - LSB) | | Bit sequence: (MSB - - - LSB) | | |
| Raw data | Binary data | Code group name | RD− | RD+ |
| 0x00 | 000 00000 | D0.0 | 100111 0100 | 011000 1011 |
| 0x01 | 000 00001 | D1.0 | 011101 0100 | 100010 1011 |
| 0xdd | 110 11101 | D30.6 | 011110 0110 | 1000001 0110 |
| - - - | - - - | - - - | - - - | - - - |

Referring to Table 1, a data conversion technique that converts 8-bit parallel data into 10-bit serial data is employed to enable reliable data transmission in high-speed communication interfaces, such as USB 3.0, 1 Gbps Ethernet (1G LAN), and PCI Express (PCIe).

USB 3.0 employs a serial data transmission method to achieve high-speed data transfer. In particular, USB 3.0 is capable of transmitting data at SuperSpeed (5 Gbps) and may ensure data integrity by utilizing a transmission scheme similar to 8b/10b encoding.

1 Gbps LAN is a network communication standard that enables high-speed data transmission and transmits data in the form of Ethernet frames.

PCI Express (PCIe) is an interface for transmitting data between various internal components of a computer system, such as a graphics card or a network interface card. PCIe enhances data transmission speed and efficiency by employing a serial data transmission method. Data is transmitted through each channel using 8b/10b encoding.

With the advancement of semiconductor manufacturing and design technologies, the present invention addresses various challenges that arise in systems where the speed of parallel data generated internally exceeds the signal transmission speed achievable over inter-system transmission lines, such as TSV-links or T-links.

To this end, at least three transmission lines are grouped to form a single link unit, and the number of such link units is scaled in accordance with the size of the data to be transmitted, thereby constructing a T-link or TSV-link.

For example, when a link unit is configured by grouping three transmission lines, the total number of transmission lines required for the link becomes 3×N, where N is an integer. In another example, when a link unit is configured by grouping four transmission lines, the total number of transmission lines required becomes 4×N. Similarly, a link unit may be configured by grouping five or more transmission lines, depending on system requirements. For instance, when 64 transmission lines are allocated for a link, 16 link units (i.e., 64/4=16) are formed by grouping four transmission lines per link unit.

A Pulse Amplitude Modulation (PAM) signal is utilized in each individual transmission line that constitutes a link unit (i.e., a group of transmission lines). The signal levels of the PAM signal may be configured as PAM3, PAM4, PAM5, PAM6, PAM7, and the like. Since the interface voltage or current applied to the transmission lines may vary depending on the specific application, the PAM signal levels are defined as relative values, as illustrated in Table 2 below.

TABLE 2

| | | Number | PAM signal values |
|---|---|---|---|
| | | of | (relative values) |
| Number | Name | signal | (signal level) |
| 1 | PAM3 | 3 | −1, 0, +1 |
| 2 | PAM4 | 4 | −3, −1, +1, +3 |
| 3 | PAM5 | 5 | −2, −1, 0, +1, +2 |
| 4 | PAM6 | 6 | −5, −3, −1, +1, +3, +5 |
| 5 | PAM7 | 7 | −3, −2, −1, 0, +1, +2, +3 |

Referring to Table 2, the PAM3 signal uses three signal levels: −1, 0, and +1. The PAM4 signal uses four signal levels: −3, −1, +1, and +3. The PAM5 signal uses five signal levels: −2, −1, 0, +1, and +2. The PAM6 signal uses six signal levels: −5, −3, −1, +1, +3, and +5. The PAM7 signal uses seven signal levels: −3, −2, −1, 0, +1, +2, and +3.

The number of symbols, that is, the types of signals that can be expressed by one link unit, is given by MAN, where M is the number of transmission lines in the link unit, and N is the number of PAM signal levels. Here, both M and N can be extended to values such as 3, 4, 5, 6, 7, and so on, as needed.

The number of PAM signal levels may be defined to be equal to or greater than the number of transmission lines. For example, when the number of PAM signal levels is three, PAM3 is defined, which has three signal levels: −1, 0, +1. Moreover, when the number of PAM signal levels is four, PAM4 is defined, which has four signal levels: −3, −1, +1, +3. Moreover, when the number of PAM signal levels is five, PAM5 is defined, which has five signal levels: −2, −1, 0, +1, +2.

However, for optimal BER improvement, it is preferable that the number of PAM signal levels matches the number of transmission lines.

Hereinafter, processes for defining the number and form of symbols to be used in the present invention will be described.

Among the symbols having the number of all cases generated by the combination of M\hat{ }N described above, a polygon having the same number of vertices as the number of transmission lines used in each link unit is constructed by applying a graph coloring theory. For example, if the number of transmission lines is 3, 4, 5, and 6, respectively, it constitutes a triangle, a square, a pentagon, and a hexagon.

Each transmission line is assigned to a vertex of a configured polygon (e.g., triangle, rectangle, etc.). A line segment (representing a signal difference) is then assigned to each edge connecting two vertices, based on principles of graph theory. The assigned line segment values do not overlap each other.

When the sum of the PAM values expressed in the transmission line constituting the link unit is “0”, and all non-overlapping line segments connecting each vertex (transmission line) are connected, only the symbol corresponding to the case where the value of the connected line segment and the value of the connected vertex are all different is selected and defined as the final symbol.

The selected final symbols are values at both ends of the vertex of the line segments (i.e., the PAM values of the transmission line). Therefore, for all symbols in the process of transmitting/receiving symbols, there is a differential value (a value other than “0”, in which 0 or 1 is explicitly present in the comparator circuit).

Therefore, the transmission/reception of selected final symbols has the same effect as the communication method using a differential signal. In the communication field for data transmission, this differential signal transmission method has excellent signal transmission characteristics even in noise, power noise, and low-level transmission lines on transmission lines, and thus, the effect of improving BER can be expected.

In addition, by using only symbols whose PAM values across the transmission lines of the link unit sum to zero, the energy consumption required for signal transmission remains constant regardless of the symbol being transmitted. This uniform power consumption simplifies power management and system design while also reducing electromagnetic interference (EMI) radiation noise.

A detailed explanation with examples is provided as follows.

### Example 1

When three transmission lines A, B, and C are configured to form a link unit, and a PAM3 signal is employed, the total number of symbols that may be expressed in a link unit is 27, which corresponds to MAN (i.e., 3\hat{ }3=27), where M denotes the number of signal levels and N denotes the number of transmission lines. Here, PAM4, PAM5, etc. having more signal levels than PAM3 may be utilized. However, PAM3 signals are used to improve the BER and to maximize the difference in signal levels between transmission lines.

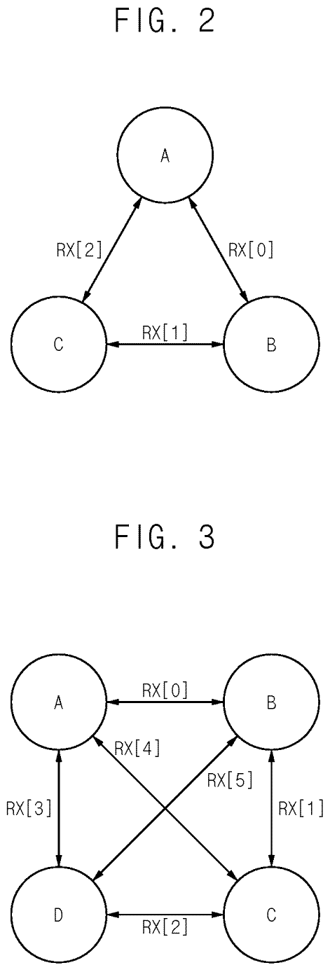

FIG. 2 is a diagram for explaining a graph figure for inference using graph coloring theory when there are three transmission lines constituting a link unit.

Referring to FIG. 2, transmission lines A, B, and C are assigned to vertices on a triangle as used in a graph coloring theory, and line segments connecting all the vertices without overlapping each other are defined. Here, the defined line segments are RX[0], RX[1] and RX[2].

When the PAM3 values assigned to transmission lines A, B, and C are summed, the total becomes zero (i.e., A+B+C=0). Among the total of 27 possible symbol combinations, only six combinations remain when selecting only those cases in which both endpoints (i.e., vertices) of each of the line segments RX0, RX1, and RX2 have different values. In the present embodiment, these six combinations are defined as final symbols to be used for communication. The six final symbols are presented in Table 3 below.

TABLE 3

| | PAM3 value | | | | Line segment value of graph theory (difference value) | | | |
|---|---|---|---|---|---|---|---|---|
| | Value by | | | Sum of | | | | RX[0:2] |
| | Transmission Line | | | transmission | RX[0] | RX[1] | RX[2] | (Decimal |
| Symbol | A | B | C | lines | (A − B) | (B − C) | (C − A) | digits) |
| 0 | −1 | 0 | 1 | 0 | 0 | 0 | 1 | 1 |
| 1 | −1 | 1 | 0 | 0 | 0 | 1 | 1 | 3 |
| 2 | 0 | −1 | 1 | 0 | 1 | 0 | 1 | 5 |
| 3 | 0 | 1 | −1 | 0 | 0 | 1 | 0 | 2 |
| 4 | 1 | −1 | 0 | 0 | 1 | 0 | 0 | 4 |
| 5 | 1 | 0 | −1 | 0 | 1 | 1 | 0 | 6 |

Referring to Table 3, a final symbol using the PAM3 signal is defined for a link unit composed of three transmission lines A, B, and C. Table 3 illustrates each final symbol along with the corresponding PAM3 value assigned to each of the transmission lines.

A digital value having six possible states (e.g., decimal numbers 0 to 5) is defined to be allocated to the six final symbols in a one-to-one correspondence. Based on the above definition, data communication is performed by encoding the digital value into a corresponding symbol during transmission and decoding the received symbol back into the digital value during reception.

### Example 2

When four transmission lines A, B, C, and D are configured to form a link unit and PAM4 signals are used, the total number of symbols that can be represented in the link unit is 256, which corresponds to MAN (i.e., 4\hat{ }4=256), where M denotes the number of signal levels and N denotes the number of transmission lines.

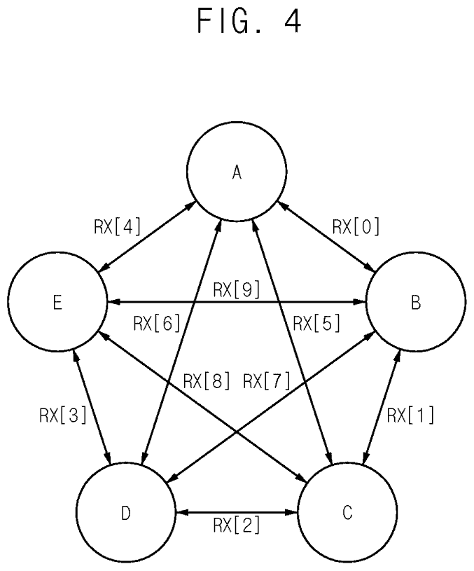

FIG. 3 is a diagram for explaining a graph figure for inference using graph coloring theory when there are four transmission lines constituting a link unit.

Referring to FIG. 3, transmission lines A, B, C, and D are assigned to respective vertices of a quadrangle, in accordance with the concept of graph coloring theory. Line segments connecting each pair of the vertices without overlapping one another are defined. Here, the defined line segments are denoted as RX[0], RX[1], RX[2], RX[3], RX[4], and RX[5].

When the PAM4 values assigned to transmission lines A, B, C, and D are summed, the total becomes zero (i.e., A+B+C+D=0), and only when both ends (vertexes) of all the line segments RX[0], RX[1], RX[2], RX[3], and RX[5] have different values, only 24 symbols remain among the total 256 symbols. In the present embodiment, 24 symbols are defined as final symbols to be used in communication. As shown in Table 4 below, 24 symbols are defined as final symbols.

[ [symbol] 4]

| Symbol | | PAM4 value | | | | | Line segment value of graph theory (difference value) | | | | | | |
|---|---|---|---|---|---|---|---|---|---|---|---|---|---|
| Decimal/ | | Value by | | | | Sum of | | | | | | | RX[0:5] |
| 24 | | Transmission Line | | | | transmission | RX[0] | RX[1] | RX[2] | RX[3] | RX[4] | RX[5] | (Decimal |
| Decimal | Name | A | B | C | D | lines | (A − B) | (B − C) | (C − D) | (D − A) | (A − C) | (B − D) | digits) |
| 0 | A0 | −3 | −1 | 1 | 3 | 0 | 0 | 0 | 0 | 1 | 0 | 0 | 4 |
| 1 | A1 | −3 | −1 | 3 | 1 | 0 | 0 | 0 | 1 | 1 | 0 | 0 | 12 |
| 2 | A2 | −1 | −3 | 1 | 3 | 0 | 1 | 0 | 0 | 1 | 0 | 0 | 36 |
| 3 | A3 | −1 | −3 | 3 | 1 | 0 | 1 | 0 | 1 | 1 | 0 | 0 | 44 |
| 4 | A4 | −3 | 1 | −1 | 3 | 0 | 0 | 1 | 0 | 1 | 0 | 0 | 20 |
| 5 | A5 | −3 | 3 | −1 | 1 | 0 | 0 | 1 | 0 | 1 | 0 | 1 | 21 |
| 6 | A6 | −1 | 1 | −3 | 3 | 0 | 0 | 1 | 0 | 1 | 1 | 0 | 22 |
| 7 | A7 | −1 | 3 | −3 | 1 | 0 | 0 | 1 | 0 | 1 | 1 | 1 | 23 |
| 8 | A8 | −3 | 1 | 3 | −1 | 0 | 0 | 0 | 1 | 1 | 0 | 1 | 13 |
| 9 | A9 | −3 | 3 | 1 | −1 | 0 | 0 | 1 | 1 | 1 | 0 | 1 | 29 |
| 10/A | A10 | −1 | 1 | 3 | −3 | 0 | 0 | 0 | 1 | 0 | 0 | 1 | 9 |
| 11/B | A11 | −1 | 3 | 1 | −3 | 0 | 0 | 1 | 1 | 0 | 0 | 1 | 25 |
| 12/C | B0 | 3 | 1 | −1 | −3 | 0 | 1 | 1 | 1 | 0 | 1 | 1 | 59 |
| 13/D | B1 | 3 | 1 | −3 | −1 | 0 | 1 | 1 | 0 | 0 | 1 | 1 | 51 |
| 14/E | B2 | 1 | 3 | −1 | −3 | 0 | 0 | 1 | 1 | 0 | 1 | 1 | 27 |
| 15/F | B3 | 1 | 3 | −3 | −1 | 0 | 0 | 1 | 0 | 0 | 1 | 1 | 19 |
| 16/G | B4 | 3 | −1 | 1 | −3 | 0 | 1 | 0 | 1 | 0 | 1 | 1 | 43 |
| 17/H | B5 | 3 | −3 | 1 | −1 | 0 | 1 | 0 | 1 | 0 | 1 | 0 | 42 |
| 18/I | B6 | 1 | −1 | 3 | −3 | 0 | 1 | 0 | 1 | 0 | 0 | 1 | 41 |
| 19/J | B7 | 1 | −3 | 3 | −1 | 0 | 1 | 0 | 1 | 0 | 0 | 0 | 40 |
| 20/K | B8 | 3 | −1 | −3 | 1 | 0 | 1 | 1 | 0 | 0 | 1 | 0 | 50 |
| 21/L | B9 | 3 | −3 | −1 | 1 | 0 | 1 | 0 | 0 | 0 | 1 | 0 | 34 |
| 22/M | B10 | 1 | −1 | −3 | 3 | 0 | 1 | 1 | 0 | 1 | 1 | 0 | 54 |
| 23/N | B11 | 1 | −3 | −1 | 3 | 0 | 1 | 0 | 0 | 1 | 1 | 0 | 38 |

Referring to Table 4, four transmission lines (A, B, C, and D) constitute the link unit, and the final symbols using the PAM4 signal are defined. Table 4 also illustrates the mapping between each symbol and the corresponding PAM4 values assigned to each transmission line.

Digital values corresponding to 24 types of symbols (e.g., decimal numbers 0 to 23) are defined to be mapped to the 24 symbols in a one-to-one manner. According to this definition, communication is performed by encoding the data into symbols during transmission and decoding the received symbols back into data during reception.

### Example 3

When five transmission lines (A, B, C, D, and E) constitute a link unit and PAM5 signals are used, the total number of symbols expressible by the link unit is given by MAN, which corresponds to 3125 (i.e., 5\hat{ }5=3125).

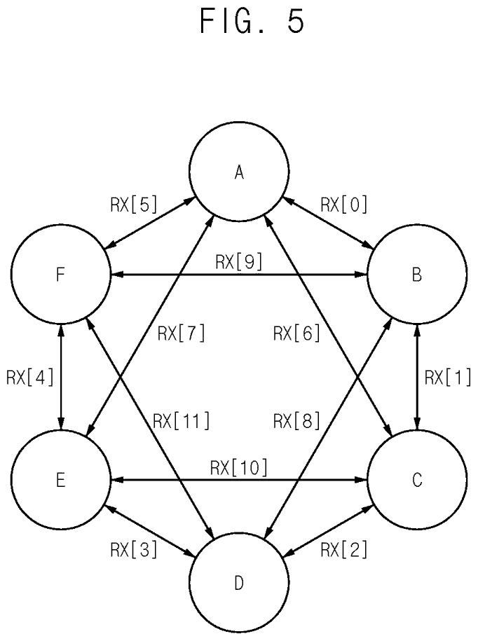

FIG. 4 is a diagram for explaining a graph figure for inference using graph coloring theory when there are five transmission lines constituting a link unit.

Referring to FIG. 4, each transmission line A, B, C, D, and E is assigned to vertices of a pentagon according to graph coloring theory, and line segments connecting all vertices are defined without overlap. The defined line segments correspond to RX[0], RX[1], RX[2], RX[3], RX[4], RX[5], RX[7], RX[8], and RX[9]. The number of symbols inferred from the 10 comparators selected by the graph coloring theory for PAM5 is 120.

A detailed description of the graph figure for inference of FIG. 4 may be easily inferred from the contents described in FIG. 2 and FIG. 3, and thus a detailed description thereof will be omitted.

### Example 4

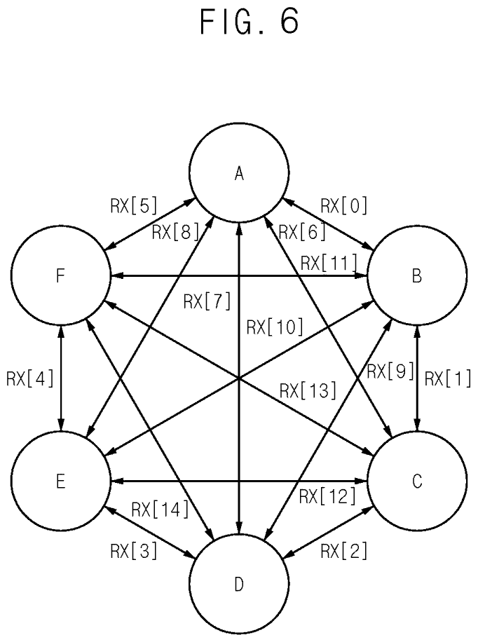

FIG. 5 is a diagram for explaining a graph figure for inference using graph coloring theory when there are six transmission lines constituting a link unit.

Referring to FIG. 5, when a PAM6 signal is used and a link unit is implemented with six transmission lines, a graph diagram for reasoning using a graph coloring theory for selecting a symbol is illustrated as a graph figure consisting of 12 line segments (comparators).
for inference of FIG. 5 may be easily inferred from the contents described in FIG. 2 and FIG. 3, so a detailed description thereof is omitted.

### Example 5

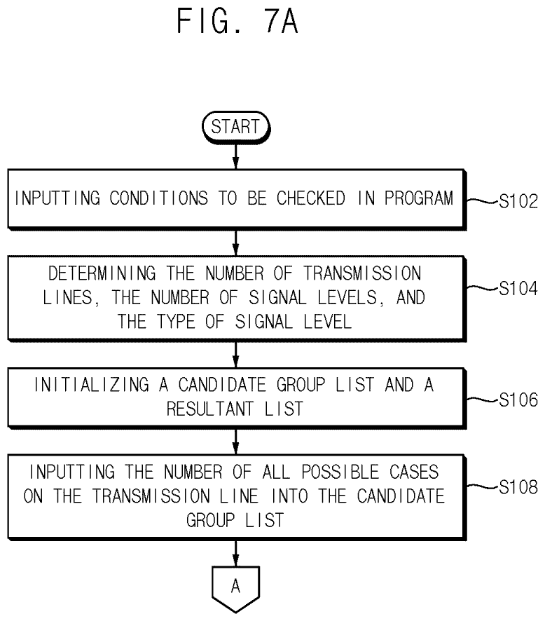

FIG. 6 is a diagram for explaining a graph figure for inference using graph coloring theory when there are six transmission lines constituting a link unit.

Referring to FIG. 6, when a PAM6 signal is used and a link unit is implemented with six transmission lines, a graph diagram for reasoning using a graph coloring theory for selecting a symbol is illustrated as a graph figure consisting of 15 line segments (comparators). According to the graph coloring theory applied to PAM6, the number of symbols that can be inferred from the 15 comparators is 720.

Since the detailed description of the graph of FIG. 6 may be easily inferred from the contents described in FIG. 2 and FIG. 3, the detailed description will be omitted.

Symbols, which are PAM signal pairs used to represent electrical signals on each transmission line for parallel data communication using the aforementioned PAM signal, may be selected through a program based on the principles of a graph coloring algorithm.

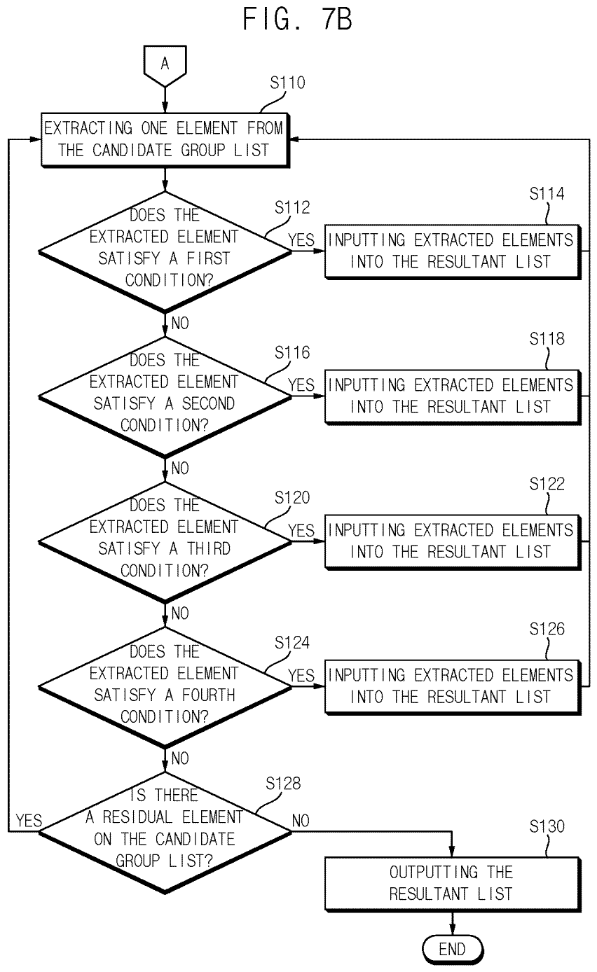

FIG. 7A and FIG. 7B are flowcharts for explaining symbol selection according to the present invention

Referring to FIG. 7A and FIG. 7B, the program receives input conditions for selecting a symbol, namely a first condition, a second condition, a third condition, and a fourth condition (step S102). In the present embodiment, the first to fourth conditions may be input as Boolean data types. The first condition requires that the sum of difference values, based on the common voltage of all transmission lines, equals 0 V. The second condition requires that adjacent transmission lines have different signal levels. The third condition requires that the transmission lines correspond to elements converted into differential signals by comparing the signal levels of adjacent transmission lines, thereby forming differential signals. The fourth condition requires that the signal is converted into differential signals through signal level comparison between adjacent transmission lines and exhibits differential signals.

Subsequently, the number of transmission lines and the number of signal levels are input, and the type of signal level is determined (step S104). Here, the number of transmission lines refers to the number of transmission lines used in communication. The number of signal levels is selected from, for example, the range of signal levels supported by the transmission lines, typically between 2 and 7. The type of signal level may be determined based on the correlation illustrated in Table 5 below according to the selected signal level. Although the type of signal level is represented as simple numerical values in Table 5, this representation is intended to intuitively describe relative signal levels and corresponds to relative symbolic values rather than actual physical signals.

TABLE 5

| | Number | PAM signal values |
|---|---|---|
| | of | (relative values) |
| Name | signals | (signal level) |
| PAM2 | 2 | 0, +1 |
| PAM3 | 3 | −1, 0, +1 |
| PAM4 | 4 | −3, −1, +1, +3 |
| PAM5 | 5 | −2, −1, 0, +1, +2 |
| PAM6 | 6 | −5, −3. −1, +1, +3, +5 |
| PAM7 | 7 | −3, −2. −1, 0, +1, +2, +3 |

Subsequently, the candidate group list and the resultant list are initialized (step S106). The candidate group list and the resultant list are implemented as Python list data types and are initialized as empty lists.

Subsequently, the candidate group list is populated with all possible cases that may occur on the transmission lines, taking into account the number of transmission lines, the number of signal levels, and the type of signal levels (step S108). For example, when the number of transmission lines is 2 and the number of signal levels is 2, the types of signal levels are 0V and 1V, as may be confirmed in Table 5. Therefore, the number of all cases that may occur based on the level of transmission line 1 and transmission line 2 is (0V, 0V), (0V, 1V), (1V, 0V), and (1V, 1V).

Subsequently, one element is extracted from the candidate group list (step S110). Each element represents one possible case corresponding to the number of transmission lines and signal levels, such as (0V, 0V), (0V, 1V), etc. As long as the candidate group list is not empty, one element is extracted from the front of the list using the pop method of the Python list.

Subsequently, it is checked whether the extracted element from step S110 satisfies the first condition (step S112).

When the extracted element in step S112 satisfies the first condition, the element is added to the resultant list (step S114), and then the process returns to step S110. Through this iterative procedure, only elements that satisfy the first condition—where the sum of the signal levels of all transmission lines equals 0V based on the common mode voltage—are extracted. For example, when there are 4 transmission lines and 4 signal levels, the combination (−3V, −1V, 1V, 3V) satisfies the first condition because the sum is 0V. In contrast, (−1V, 1V, 1V, 3V) does not satisfy the condition because the sum is 4V.

When it is checked that one element extracted in step S112 does not satisfy the first condition, it is checked whether the extracted one element satisfies the second condition (step S116).

When one element extracted in step S116 is checked to satisfy the second condition, the extracted element is inputted to the resultant list (step S118), and then the resultant is fed back to step S110. Through this process, elements satisfying the second condition in which adjacent transmission lines have different signal levels may be extracted. For example, when the number of transmission lines is 4 and the number of signal levels is 4, (level of transmission line 1, level of transmission line 2, level of transmission line 3, level of transmission line 4)=(−3V, −1V, 1V, 3V) satisfies the first condition because all adjacent transmission lines have different signal levels, and (1V, 1V, 1V, −3V) satisfies the first condition because (1V, 1V, 1V) is adjacent to transmission line 1, and 2 is adjacent to transmission line 2, and 3 is adjacent to each other, and has the same signal level, and thus does not satisfy the second condition.

When it is checked that the one element extracted in step S116 does not satisfy the second condition, it is checked whether the extracted one element satisfies the third condition (step S120).

When one element extracted in step S120 is identified as satisfying the third condition above, the extracted element is input into the output list (step S122), and then feedback to step S110. Through this process, in order to confirm the third condition above, each element is converted into a differential signal, and for this purpose, signal level comparison between adjacent transmission lines is performed. For example, when the number of transmission lines is 4 and the number of signal levels is 4, (level of transmission line 1, level of transmission line 2, level of transmission line 3, level of transmission line 4)=(−3V, 3V, −3V, 3V) is converted into a differential signal of (level of transmission line 1> level of transmission line 2>level of transmission line 3), (level of transmission line 3>level of transmission line 4), (level of transmission line 4>level of transmission line 1)=(0,1,0,1). This process aims to find only elements that have different differential signals when the signal levels of the transmission line are converted into differential signals as above, so the third condition determines whether there is an element that has the same differential signal in the past when the signal levels of each element are converted into differential signals. For example, the (−3V, 3V, −3V, 3V) signal is converted into a differential signal of (0,1,0,1), which has the same differential signal as (−3V, 3V, −1V), so only one of the two elements satisfies the third condition.

When it is checked that one element extracted in step S118 does not satisfy the third condition, it is checked whether the extracted one element satisfies the fourth condition (step S124).

When one element extracted in step S124 is identified as satisfying the above fourth condition, the extracted element is inputted in the output list (step S126), and the feedback is made to step S110. The process of converting each element into a differential signal not only compares the signal levels between adjacent transmission lines but also compares the signal levels between adjacent transmission lines. For example, when the number of transmission lines is 4 and the number of signal levels is 4, (level of transmission line 1, level of transmission line 2, level of transmission line 3, level of transmission line 4)=(1V, −3V, 3V, 1-1V) signals are converted to differential signals when the signal levels of the transmission line are converted to differential signals as described above, [(level of transmission line 1> level of transmission line 2>level of transmission line 3), (level of transmission line 4>level of transmission line 1), (level of transmission line 3), (level of transmission line 1) (level of transmission line 1>level of transmission line 3), and (level of transmission line 2>level of transmission line 4)=(1,0,0,0,0). Similar to the process under the third condition, this process also aims to find only elements with different differential signals when the signal levels of the transmission line are converted to differential signals. For example, the (1V, −3V, 3V, −1V) signal is converted into a differential signal of (1,0,1,0,0), which has the same differential signal as (1V, −1, 1V, −1V), and thus only one element of the element satisfies the fourth condition. Here, as the number of transmission lines increases in the process of converting to the differential signal, signal comparison between the pair of more transmission lines proceeds.

When it is checked that one element extracted in step S124 does not satisfy the fourth condition, whether a residual element exists in the candidate group list is checked (step S128). When it is checked that a residual element exists in step S128, the feedback is made to step S110.

When it is checked that no residual element exists in the candidate group list in step S128, the resultant list is output (step S130).

Referring back to FIG. 1, a system positioned at both ends of a transmission line and serving as a communication subject for transmitting and receiving generated data may be configured with two processor units connected to each other. Additionally, the communication system may be structured such that a processor unit and a memory device, such as a High Bandwidth Memory (HBM), are disposed on one side, and a DRAM die and a base logic die of the HBM are disposed on the other side.

A link, which serves as a physical signal connection between communication subjects, includes a data link and a control link. The data link is configured to transmit and receive data, while the control link is configured to support functions such as communication enable/disable, direction control, data read/write, idle state signaling, start and stop control, error checking, built-in testing, and loopback testing of the transmission line.

In the present specification, the data link is mainly described, and the control link is assumed to be sufficiently controlled to satisfy the progress of communication without specification. Hereinafter, the data link will be referred to as a link.

Although the present invention is premised on supporting bidirectional communication, the following description primarily illustrates a case in which data is transmitted from one end and received at the other end. Since data transmission and reception in the opposite direction correspond to the reverse of the described process, a detailed description thereof will be omitted for the sake of brevity.

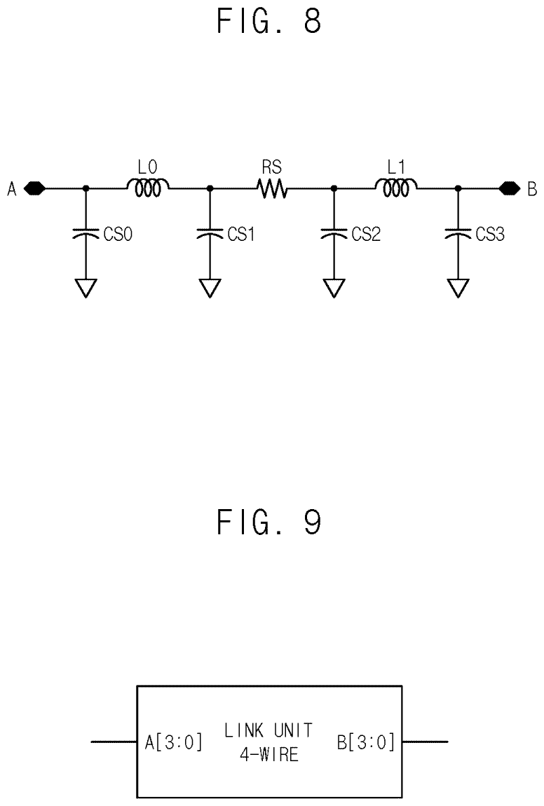

FIG. 8 is an electrical equivalent modeling circuit for one transmission line shown in FIG. 1.

Referring to FIG. 8, L0 denotes an inductance component, RS denotes a series resistance component representing impedance, L1 denotes a reactance component, and CS0 through CS2 represent parasitic capacitance components modeled as part of the transmission line. The inductance component L0 and the series resistance RS are relatively small and have a minor effect on high-speed signal transmission. In contrast, the parasitic capacitance components CS0 to CS2, though also relatively small, have the greatest impact on high-speed parallel signal transmission.

When a plurality of transmission line models are configured, cross-coupling capacitance between the transmission lines may also exist; however, this invention does not specifically describe such cross-coupling capacitance.

In some embodiments, a transmission line is utilized to couple adjacent chips. In one aspect, the transmission lines may increase the available periphery for chip-to-chip connection, and overall capacity. In another aspect, the transmission lines can be utilized for increased bandwidth of chip-to-chip communication, with mitigated latency.

In one implementation, a transmission line may be utilized as a communication line between logic chips. In such an implementation, the transmission line may be oriented toward communications, meeting bandwidth, power, latency and cost goals. The logic chips, such as system on chip (SOC), may include central processing units (CPU) or graphics processing units (GPU). In addition, the logic chip periphery may be formatted to enable memory integration and other in/out (I/O) to other devices.

The transmission lines may support metal stacks, and logic (e.g. transistor types) compatible with communication function. The transmission lines may be packaged in a variety of configurations, including chip on wafer (CoW) and 2.5D packaging techniques. CoW may also be a 2.5D or 3D arrangement, for example. Here the individual chips are bonded together (chip-to-chip), or to an interposer (chip-interposer-chip). The joining technologies may be micro-bumps (dense I/O), or ACF, or hybrid bonding (metal-metal) supporting very dense IO, or even optical. Instead of individual chips, wafer to wafer (W2 W) bonding is also possible, and can be used as per application. For example, CoW may involve the singulated area of the support wafer, or panel, being bigger than the chip mounted on the support wafer, while W2 W may involve equal areas of the singulated wafers, or panels. 2.5D packaging may use a smaller dense interconnect connection between two chips. The chiplets used for 2.5D packaging may be a smaller length passive bridge, or longer length, arranged as transmission lines. These transmission lines provide options to balance bandwidth, power, complexity, thermal and power delivery and other architectural requirements. Further the transmission lines can be active silicon (or other device technology like GaAs). The transmission lines may also be encapsulated in a molding compound, and optionally include multiple components connects by bridges. Thus, a transmission line utilized for 2.5D packaging can also be individually formed and packaged using 2.5D packaging. Larger transmission lines may also place special requirements in assembly to substrates, to manage the mechanical stress, and other assembly issues. The connection between the chip and transmission line may be using solder (micro-bumps), or ACF, and hybrid bonds (metal-metal). In some exemplary implementations, CoW integration may be utilized for performance logic with dense I/O using micro-bumps or even denser hybrid bonding. In some implementations CoW integration may include hybrid bonding of silicon chiplets with interposer. In some embodiments CoW integration may include silicon chiplets connected with back-end-of-the-line (BEOL) interconnections, in chip-like fashion. For example, the silicon chiplets may have partial BEOL build-up structure and interconnections, with subsequent second level BEOL build-up structure that connects the silicon chiplets, with a chip-like fashion. The silicon chiplets may be embedded in an inorganic gap fill (e.g. oxide) material upon which the second level BEOL build-up structure is formed. 2.5D packaging in some embodiments may be utilized for chip set light functions with moderate bandwidth and latency requirements.

In one implementation, a transmission line may be utilized as a memory bar to couple a group of memory chips to a logic chip. The group of memory chips may be laterally separate. Additionally, the laterally separate memory chips may each be packaged, or part of a die stack with multiple dies, or module. Thus, laterally separate chips in accordance with embodiments may be a part of laterally separate packages, die stacks, or modules. In one aspect, the transmission lines may enable logic chips to communicate with DRAM chips of various types, including LPDDR-x, DDR, HMB, etc. In accordance with embodiments, memory chips are not limited to DRAM, or variations of LPDDR-x, DDR, HBM, etc. Likewise, logic chips may include a variety of functions such as, but not limited to, SOC, CPU, GPU, caches, signal processors, glue logic, etc., and may be based on silicon, or other technology (e.g. GaAs). The transmission lines may include local controllers compatible to memory type, as well as a physical interface (PHY) (e.g. PHY analog and PHY digital controller) compatible with the memory. In some implementations, the memory bars are packaged in configurations such as 2.5D packages, multi-chip modules (MCM), and MCM plus bridge. Additionally, the memory bars may be packaged in a variety of shapes for routing, such as L-shaped.

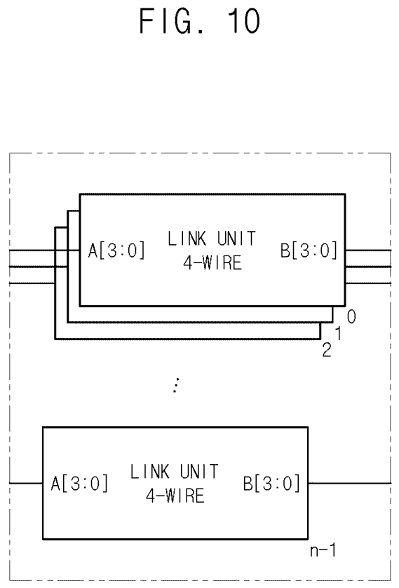

FIG. 9 is a circuit symbol for explaining a link unit with four transmission lines shown in FIG. 8.

Referring to FIG. 9, four transmission lines are grouped to form a single bundle, thereby defining one link unit. Although FIG. 9 illustrates an example in which a link unit is defined by four transmission lines, various implementations such as a T-link, a TSV-link, a PCB pattern, or a physical connection line may likewise be configured using four transmission lines.

A link unit may be configured by grouping 16 to 32 bundles of transmission lines, and the link may be extended to include from 64 up to 128 transmission lines. In other words, multiple transmission lines constitute a link unit, and multiple link units collectively define a link. If necessary, the link may be further expanded to include 256, 512, 1024, 2048, or more transmission lines.

Communication units connected at both ends of the link are extended in number corresponding to the number of link unit bundles that define the link, thereby constituting a communication module. In the present specification, multiple communication units collectively are referred to as a communication module.

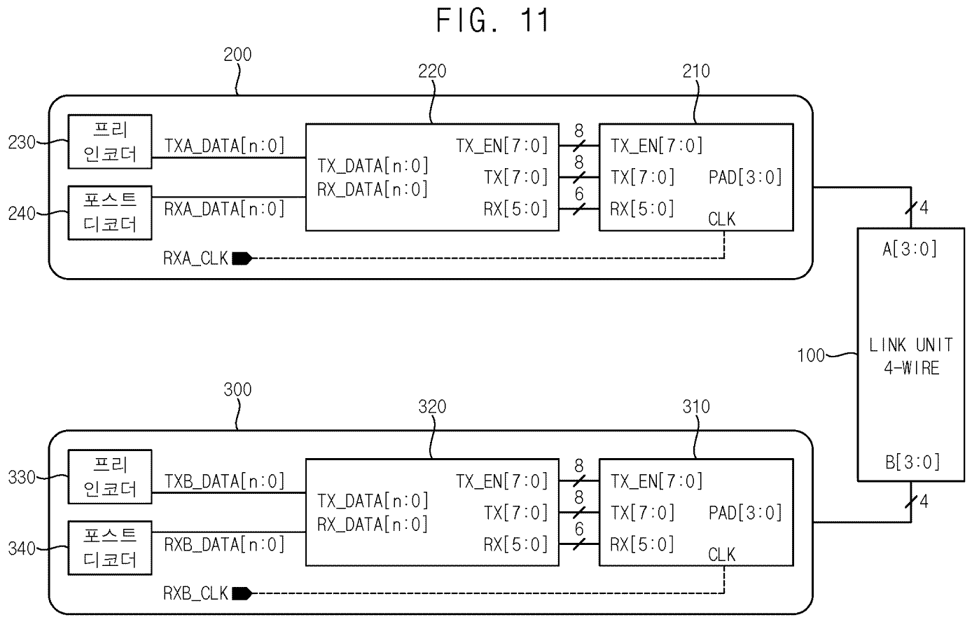

FIG. 10 is a diagram for explaining the concept of configuring a link by the n link units shown in FIG. 9.

Referring to FIG. 10, a link is defined by configuring n link units as a group. When two or more link units are extended, each communication module may include a mapping module for transmitting data and a remapping module for receiving data.

Specifically, for data transmission in a communication module, a mapping module may be additionally employed to convert binary (BIN) or hexadecimal (HEX) data used by a processor unit or computing system into a binary number based on the symbol number defined in each communication unit, and to allocate the converted binary value as a symbol signal in accordance with the symbol definition of each communication unit. In the case of PAM4 utilizing four transmission lines, up to 24 symbols may be transmitted per communication unit.

For example, when 64-bit data (e.g., 64 bundles of binary digits or 16 bundles of hexadecimal digits) are converted into 14 bundles of 24-binary digits, a logic block configured to allocate the values of the converted 24-binary digits as symbols of each communication unit may be employed. These logic blocks comprise combinational logic, which is a type of logic circuit whose output is determined solely by current input values. The logic blocks may be designed to perform binary conversion at a 1-clock data transmission speed without incurring significant overhead, based on current advanced semiconductor manufacturing technologies.

Additionally, for data reception in the communication module, a remapping module is employed to restore the original data by converting the received data of each communication unit into symbols, and subsequently converting the symbols into binary or hexadecimal (BIN) data used by each processor unit or computing system, in accordance with the predefined symbol definition.

For example, a logic block may be used to convert received data into a symbol, convert the symbol into a 14-bundle of 24-binary digits, and further convert it into 64-bit data (e.g., a 64-bundle of binary digits or a 16-bundle of hexadecimal digits), which is then transmitted to the processor unit. The logic block is composed of combinational logic, and may be designed to perform binary conversion at a 1-clock data transmission speed without significant overhead, based on current advanced semiconductor manufacturing technologies. Hereinafter, an embodiment using m link units will be described. In this example, one link unit (m=1) includes four transmission lines, and PAM4 signaling is employed.

The following embodiment describes a link unit, which refers to a set of transmission lines. Implementing link units in a bundle of n (where n is an integer greater than 1) corresponds to an extended concept of the link unit, and therefore, a detailed description thereof will be omitted.

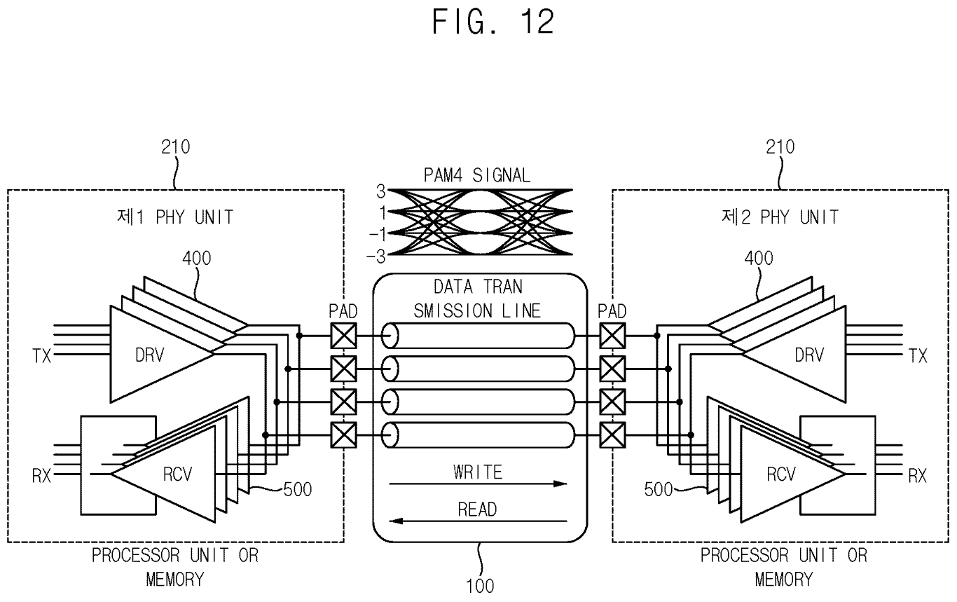

FIG. 11 is a block diagram for explaining a data communication system according to an embodiment of the present invention.

Referring to FIG. 11, a first communication unit 200 and a second communication unit 300 are respectively disposed on opposite sides of a link unit 100, which comprises four transmission lines. In the present embodiment, the first communication unit 200 may correspond to a first chiplet module, while the second communication unit 300 may correspond to a second chiplet module. A chiplet refers to a design approach that partitions a single large chip into multiple smaller modules. The first chiplet module and the second chiplet module are independent smaller chips configured to perform distinct functions, and collectively form a complete system by integrating multiple chiplets instead of a single monolithic chip.

In this embodiment, when the first communication unit 200 transmits a signal, the second communication unit 300 receives the signal. Conversely, when the second communication unit 300 transmits a signal, the first communication unit 200 receives the signal.

The first communication unit 200 includes a first PHY unit 210 connected to one side of the link unit 100 to perform transmission and reception of PAM signals, a first encoding/decoding unit 220 connected to the first PHY unit 210, a first pre-encoder 230 connected to the first encoding/decoding unit 220, and a first post-decoder 240 connected to the first encoding/decoding unit 220.

The first PHY unit 210 includes one or more driver (DRV) blocks configured to convert an externally input voltage-level transmit (TX) signal into a current signal and output the current signal to a transmission line through an I/O pad, and one or more receiver (RCV) blocks configured to receive PAM signals transmitted through the link unit 100. Accordingly, the first PHY unit 210 performs transmission and reception of PAM signals.

The first encoding/decoding unit 220 receives transmission data (TXA_DATA[n:0]) from the first pre-encoder 230 during signal transmission, generates a symbol based on the TX signal (TX[7:0]) and the TX enable signal (TX_EN[7:0]), and outputs the generated symbol to the first PHY unit 210. During signal reception, the first encoding/decoding unit 220 restores the symbol based on the RX signal (RX[5:0]) received from the first PHY unit 210 and provides the restored symbol to the first post-decoder 240.

The first pre-encoder 230 receives data to be transmitted from a processor unit or a memory device during signal transmission and pre-encodes the data.

The first post-decoder 240 performs post-decoding on data received when data is received.

The second communication unit 300 includes a second PHY unit 310 connected to the opposite side of the link unit 100 to perform signal transmission and reception, a second encoding/decoding unit 320 connected to the second PHY unit 310, a second pre-encoder 330 connected to the second encoding/decoding unit 320, and a second post-decoder 340 connected to the second encoding/decoding unit 320.

The second PHY unit 310 includes one or more driver (DRV) blocks configured to convert an externally input voltage-level transmit (TX) signal into a current signal and output the current signal to a transmission line through an I/O pad, and one or more receiver (RCV) blocks configured to receive PAM signals transmitted through the link unit 100. Accordingly, the second PHY unit 310 performs transmission and reception of PAM signals.

The second encoding/decoding unit 320 restores a symbol based on the RX signal (RX[5:0]) received from the second PHY unit 310 during signal reception and provides the restored symbol to the second post-decoder 340. During signal transmission, the second encoding/decoding unit 320 receives transmission data (TXB_DATA[n:0]) from the second pre-encoder 330, generates a symbol based on the TX signal (TX[7:0]) and the TX enable signal (TX_EN[7:0]), and outputs the generated symbol to the second PHY unit 310.

The second pre-encoder 330 receives data to be transmitted from a processor unit or a memory device during signal transmission and performs pre-encoding on the received data.

The second post-decoder 340 performs post-decoding on data received during data reception.

Each of the first PHY unit 210 and the second PHY unit 310 may include a comparator, which may be implemented as a voltage comparator. When the comparator in the first PHY unit 210 or the second PHY unit 310 operates using a clock signal, such as RXA_CLK or RXB_CLK, the voltage comparator may be implemented as an analog regenerative memory (ARM) latch voltage comparator.

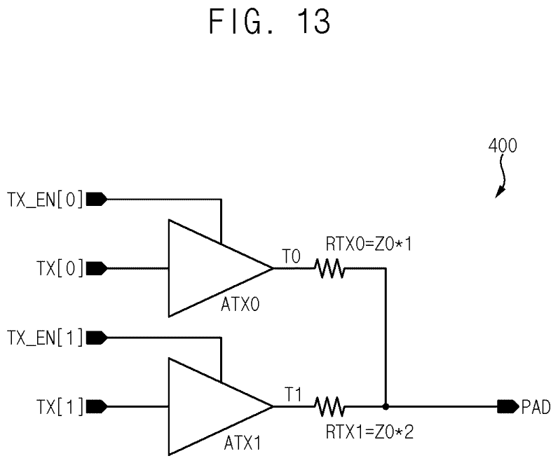

The first PHY unit 210, the link unit 100, and the second PHY unit 310 shown in FIG. 11 may be represented as shown in FIG. 12 below.

FIG. 12 is a diagram for explaining the first PHY unit 210, the link unit 100, and the second PHY unit 310 shown in FIG. 11.

Referring to FIG. 12, a first PHY unit 210 is disposed on one side of the link unit 100, and a second PHY unit 310 is disposed on the other side of the link unit 100.

The link unit 100 includes four transmission lines. In the present embodiment, since the number of transmission lines is 4, a PAM4 signal is used as a TX signal for driving each transmission line.

Each of the first PHY unit 210 and the second PHY unit 310 includes four DRV blocks 400 and four RCV blocks 500.

Each DRV block 400 is a circuit configured to drive a PAM4 signal on one transmission line. Each RCV block 500 uses four input circuits for receiving a signal from one transmission line. In the present embodiment, a circuit configuration for outputting a result of comparing four input results with six comparators configured by a graph coloring theory is illustrated.

To process the driving signal of the first transmission line, that is, the TX_EN[1], TX_EN[0], TX[0], TX[0], and PAD of the first DRV block 400 are connected to TX_EN[1], TX[0], TX[0], and PAD[0] of the first PHY unit 210, respectively.

To process the driving signal of the second transmission line, that is, the TX_EN[1], TX_EN[0], TX[0], TX[0], and PAD of the second DRV block 400 are connected to TX_EN[3], TX[2], TX[2], and PAD[1] of the first PHY unit 210, respectively.

To process the driving signal of the third transmission line, that is, the TX_EN[1], TX_EN[0], TX[0], TX[0], and PAD of the third DRV block 400 are connected to TX_EN[5], TX[4], TX[4] and PAD[2] of the first PHY unit 210, respectively.

To process the driving signal of the fourth transmission line, that is, the TX_EN[1], TX_EN[0], TX[0], TX[0], and PAD of the fourth DRV block 400 are connected to TX_EN[7], TX[6], TX[6], and PAD[3] of the first PHY unit 210, respectively.

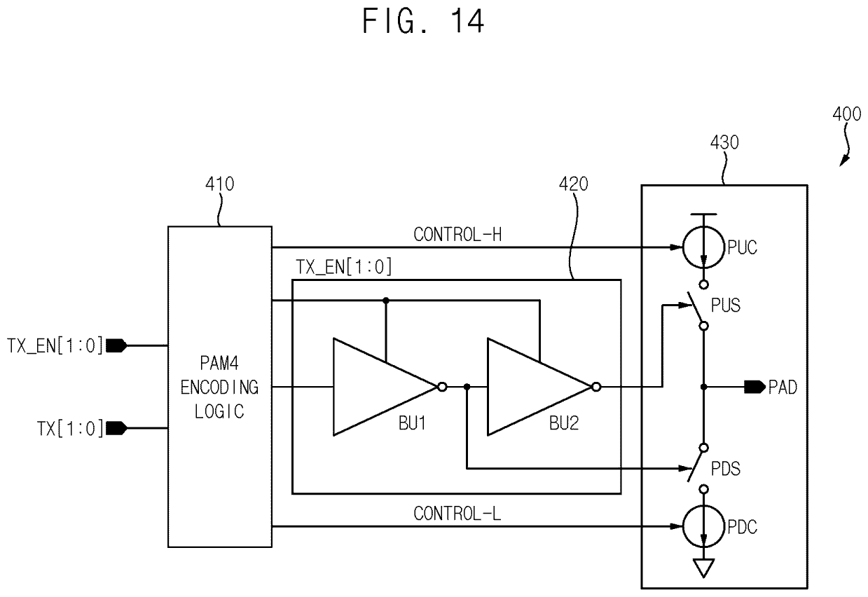

DRV blocks 400 applicable to this embodiment may be implemented with various circuits such as FIGS. 13, 14, and 15 below.

FIG. 13 is a circuit diagram for explaining an example of a DRV block shown in FIG. 12. In particular, an example of a voltage mode driver (DRV) circuit is illustrated.

Referring to FIG. 13, the DRV block 400, according to an example, includes a first TX buffer ATX0, a first TX resistor RTX0, a second TX buffer ATX1, and a second TX resistor RTX1, converts an externally input voltage level TX signal into current and outputs it to a transmission line of the link unit 100 through an I/O pad.

In the present embodiment, the first TX resistor RTX0 and the second TX resistor RTX1 may have resistance values ranging from 300Ω to 10 kΩ. Alternatively, the first TX resistor RTX0 and the second TX resistor RTX1 may be set to values for using a current between 50 μA and 300 μA as a data transmission signal according to a voltage VDD of an output circuit.

The conventional signal transmission driver (TX or DRV) circuit includes an ideal output buffer (when output impedance or Ron is 052) and a virtual resistor RT for Ron (ON resistance value) of the PMOS and NMOS FET constituting the output buffer terminal. Here, the resistor RT is set to a value between about 100 and 3000 for impedance matching of the transmission line.

On the other hand, in the present invention, an output resistor, i.e., a first TX resistor RTX0 (or a first TX resistor RTX0 and a second TX resistor RTX1) generates a transmission current by converting a voltage generated in an output buffer into a current. The above-described resistors are used to generate a constant current regardless of the impedance of the transmission line. The above-described resistors generally have a resistance value in the range of 300Ω to 10 kΩ, or are set to generate a current in the range of 50 μA to 300 μA depending on the VDD and the VCOM voltage. This is an important feature that distinguishes it from the existing technology.

For example, when the VDD is 1.0V and the VCOM is 0.5V, RTX0 (i.e., when only RTX0 is used) becomes 20 kΩ according to Equation 4 and Equation 5 when the signal transmission current is set to −25 μA. When the current is set to 100 μA, 150 μA, 200 μA, and 300 μA, the resistance values of RTX0 are calculated to be 5 kΩ, 3.333 kΩ, 2.5 kΩ, and 1.667 kΩ, respectively.

The first TX buffer ATX0 and the first TX resistor RTX0 to which the first TX signal TX[0] and the first TX enable signal TX_EN[0] are applied are connected in series to the I/O pad, and the second TX buffer ATX1 and the second TX resistor RTX1 to which the second TX signal TX[1] and the second TX enable signal TX_EN[1] are applied are connected in series to the I/O pad.

As described in FIG. 13, two TX buffers and two resistors are configured within the DRV block 400 to represent four relative magnitude current levels. Similarly, when three or more TX buffers and three or more resistors are implemented in the DRV block 400, a greater number of relative magnitude current levels may be represented. However, such configurations are not described in detail herein for the sake of brevity.

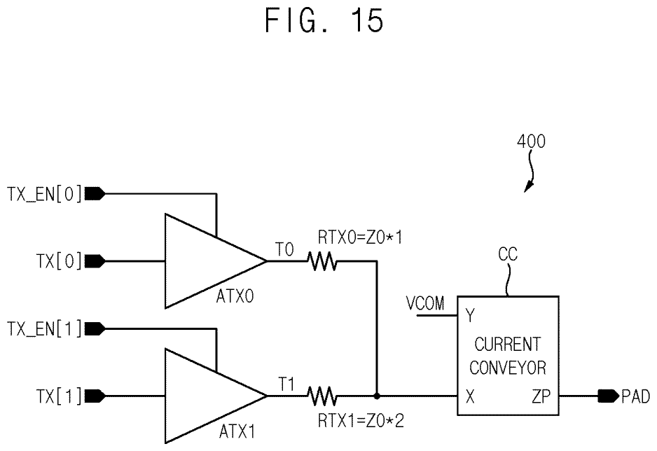

FIG. 14 is a circuit diagram for explaining another example of the DRV block shown in FIG. 12. In particular, an example of a current-mode driver circuit employing a current source (reference) method is illustrated.

Referring to FIG. 14, a DRV block 400 according to another example includes a PAM encoding unit 410, a first buffer 420, and a voltage-to-current converter 430. The DRV block 400 converts an externally input voltage-level TX signal into a current signal and outputs the current to a transmission line through an I/O pad.

The PAM encoding unit 410 encodes the TX signal based on the TX_EN signal. In the present embodiment, when the number of transmission lines is three, each TX signal driving a respective transmission line is encoded as a PAM3 signal. When the number of transmission lines is four, each TX signal driving a respective transmission line is encoded as a PAM4 signal (a four-level pulse amplitude-modulated signal).

The first buffer 420 includes a pre-inverter BU1 and a post-inverter BU2 and buffers the PAM4 signal having the voltage level encoded by the PAM encoding unit 410. The pre-inverter BU1 is enabled by the TX_EN signal to inverts the TX signal. The post-inverter BU2 is connected to the rear end of the pre-inverter BU1, and is enabled by the TX_EN signal to inverts the signal that is enabled by the pre-inverter BU1.

The voltage-to-current converter 430 includes a pull-up current source PUC, a pull-down current source PDC, a pull-up switch PUS, and a pull-down switch PDS, and converts a PAM4 signal having a voltage level buffered by the first buffer 420 into a current. The pull-up current source PUC and the pull-down current source PDC generate a first current. The pull-up current source PUC and the pull-down current source PDC may include a current source or a current mirror. The pull-up switch PUS controls an output of the first current generated in the pull-up current source PUC in response to a signal output from the rear inverter BU2 of the first buffer 420. The pull-down switch PDS controls an output of the first current generated in the pull-down current source PDC in response to a signal output from the front inverter BU1 of the buffer 310.

Accordingly, a current corresponding to a transmission voltage signal, i.e., a first current, is applied to the transmission line connected through the I/O pad. That is, in order to convert an input voltage signal into current, a current switch in which a pull-up switch PUS and a pull-down switch PDS are connected to the pull-up current source PUC and the pull-down current source PDC may be used.

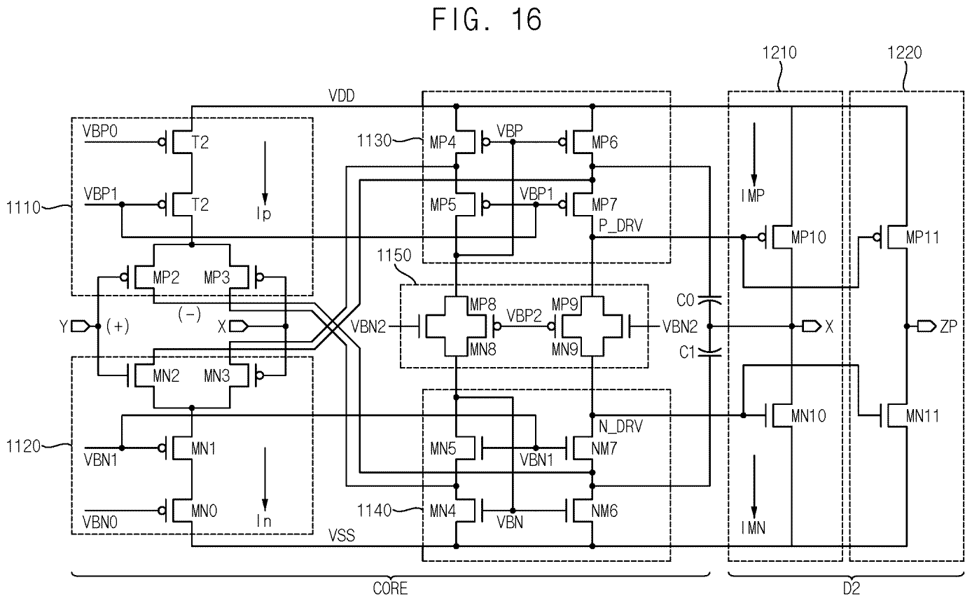

FIG. 15 is a circuit diagram for explaining another example of the DRV block shown in FIG. 12. In particular, the current mode driver DRV circuit of the current conveyor method is illustrated.

Referring to FIG. 15, a DRV block 400 according to another example includes a first TX buffer ATX0, a first TX resistor RTX0, a second TX buffer ATX1, a second TX resistor RTX1, and a current conveyor CC, converts the input voltage signal into current and provides it to the transmission line through the I/O pad.

The first TX buffer ATX0 and the first TX resistor RTX0 to which the first TX signal TX[0] and the first TX enable signal TX_EN[0] are applied are connected in series to the X-port of the current conveyor CC. The second TX buffer ATX1 and the second TX enable signal TX_EN[1] are applied to the second TX buffer ATX1 and the second TX resistor RTX1 are connected in series to the X-port of the current conveyor CC.

The current conveyor CC includes an X-port connected to the common end of the first TX resistor RTX0 and the second TX resistor RTX1, a Y-port to which a common mode voltage VCOM on the transmission line is applied, and a ZP-port connected to an I/O pad. Here, the Y-port receives the common mode voltage VCOM on the transmission line, the X-port receives the current, and the ZP-port mirrors the input current and outputs it through the I/O pad. The current conveyor CC may further include an EN-port (not shown) into which an EN signal for enabling/disabling an operation state of the current conveyor is input.

The relationship between the input signal and the output signal of the current conveyor may be defined by the following matrix.

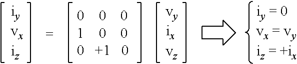

According to the matrix definition of the relationship between the symbol of the current conveyor and the signal input/output shown in FIG. 15, the current conveyor has the following characteristics.
The Y-port is a high impedance port that receives a voltage signal with an input current of “0”.
The X-port is a low impedance port having a voltage equal to that of the Y-port and receiving a current signal.
The ZP-port is a high impedance port that mirrors the input (or output) current of the X-port 1:1 and has the same current output value as the X-port.

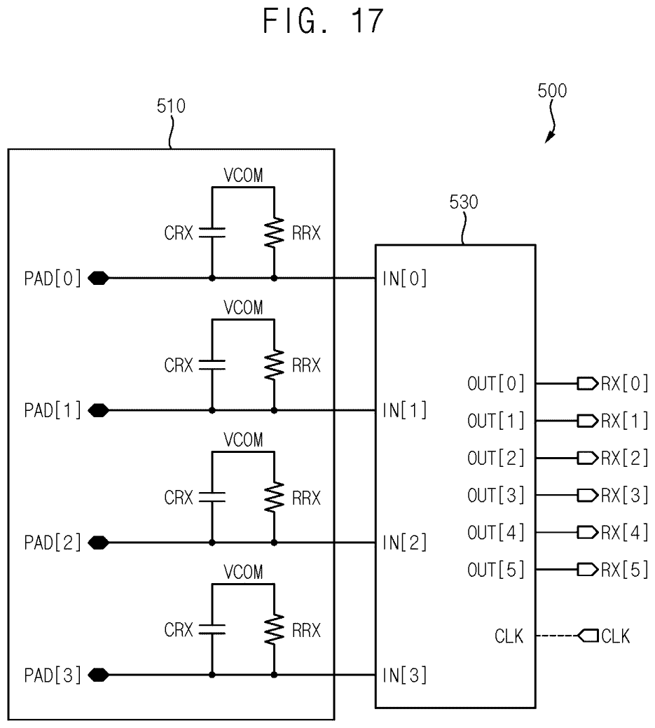

FIG. 16 is a circuit diagram for explaining an example of a current conveyor CC shown in FIG. 15. In the present embodiment, it is shown that the current conveyor is a Balanced Output Rail-to-rail Current Conveyor II.

Referring to FIG. 16, the current conveyor includes a core block CORE and a driving block D2.

The core block CORE includes an upper differential input terminal 1110, a lower differential input terminal 1120, an upper current mirror terminal 1130, a lower current mirror terminal 1140, a switching terminal 1150, a first capacitor C1, and a second capacitor C2. The core block CORE receives VBP0, VBP1, and VBP2 as bias voltages of PMOS, and receives VBN0, VBN1, and VBN2 as bias voltages of NMOS devices from a bias circuit block (not shown). In the balanced output rail-to-rail second-generation current conveyor shown in FIG. 16, the bias circuit block is omitted.

The core block CORE implements rail-to-rail input/output through the upper differential input terminal 1110 and the lower differential input terminal 1120 commonly connected to the Y-port and the X-port. The core block CORE mirrors the current applied by the bias voltage based on the voltage at the Y-port and the voltage at the X-port, and applies the first driving voltage P_DRV and the second driving voltage N_DRV to the driving block D2.

The upper differential input terminal 1110 includes a p-channel metal-oxide-semiconductor field-effect transistor (MOSFET) MP0 and a p-channel MOSFET MP1 connected in series and a p-channel MOSFET MP2 and a p-channel MOSFET MP3 connected in parallel. The p-channel MOSFET MP0 has a source to which a first power voltage VDD is applied, a gate to which a bias voltage VBP0 is applied, and a drain connected to the source of the p-channel MOSFET MP1. The p-channel MOSFET MP1 has a source connected to the drain of the p-channel MOSFET MP0, a gate to which a bias voltage VBP1 is applied, a source of p-channel MOSFET MP2, and a drain connected to the source of the p-channel MOSFET MP3. The p-channel MOSFET MP2 has a source connected to the drain of the p-channel MOSFET MP1, a gate connected to the Y-port, and a drain connected to the lower current mirror terminal 140. The p-channel MOSFET MP3 has a source connected to the drain of the p-channel MOSFET MP1, a gate connected to the X-port, and a drain connected to the lower current mirror terminal 1140. The p-channel MOSFET MP2 and p-channel MOSFET MP3 are responsible for input. The p-channel MOSFET MP2 and p-channel MOSFET MP3 compare the voltage of the Y-port and the voltage of the X-port to pass a tail current Ip applied by a bias voltage toward a gate to which a lower voltage is input. Here, a range of an operable input signal voltage (that is, a common mode voltage) is about 0.8V to about 0V, assuming that a first power voltage VDD is about 1.0V.

The lower differential input terminal 1120 includes an n-channel MOSFET MN0 and an n-channel MOSFET MN1 connected in series and an n-channel MOSFET MN2 and an n-channel MOSFET MN3 connected in parallel. The n-channel MOSFET MN0 has a drain connected to the source of the n-channel MOSFET MN1, a gate to which a bias voltage VBN0 is applied, and a source to which a second power voltage VSS is applied. The n-channel MOSFET MN1 has a drain connected to a source of the n-channel MOSFET MN2 and the source of the n-channel MOSFET MN3, a gate to which a bias voltage VBN1 is applied, and a source connected to the drain of the n-channel MOSFET MN0. The n-channel MOSFET MN2 has a drain connected to the upper current mirror end 130, a gate connected to the Y-port, and a source connected to the drain of the n-channel MOSFET MN1. The n-channel MOSFET MN3 has a drain connected to the upper current mirror terminal 1130, a gate connected to the X-port, and a source connected to the drain of the n-channel MOSFET MN1. The n-channel MOSFET MN2 and n-channel MOSFET MN3 are responsible for the input. The n-channel MOSFET MN2 and n-channel MOSFET MN3 compare the voltage of the Y-port and the voltage of the X-port to pass the current “In” applied by a bias voltage toward the gate to which the higher voltage is input. Here, a range of an operable input signal voltage (that is, a common mode voltage) is about 0.2V to about 1.0V, assuming that a first power voltage VDD is about 1.0V.

Since an upper differential input terminal 1110 and a lower differential input terminal 1120 are disposed as input stages of the current conveyor, rail-to-rail input may be implemented. That is, when a power supply is 1.0V, the tail currents ‘Ip’ and ‘In’ may be supplied so that a range of the common mode voltage covers all of the range of the first power voltage VDD.

Since the rail-to-rail input covers all of the range of the input signal, 0V to VDD, it may operate with a wider range of input voltage compared to a case where a conventional circuit receives an upper input or a lower input.

The upper current mirror stage 1130 includes a p-channel MOSFET MP4, a p-channel MOSFET MP5, a p-channel MOSFET MP6, and a p-channel MOSFET MP7 to define the current mirror. The p-channel MOSFET MP4 has a source to which a first power voltage VDD is applied, a gate connected to a drain of the p-channel MOSFET MP5 and a gate of the p-channel MOSFET MP6, and a drain connected to a source of the p-channel MOSFET MP5. Further, the drain of the p-channel MOSFET MP4 is connected to a source of the n-channel MOSFET MN3 of the lower differential input terminal 120. The p-channel MOSFET MP5 has a source connected to the drain of the p-channel MOSFET MP4, a gate connected to a gate of the p-channel MOSFET MP7, and a drain connected to the gate of the p-channel MOSFET MP4. Further, the source of the p-channel MOSFET MP5 is connected to the source of the n-channel MOSFET MN3 of the lower differential input terminal 120. The p-channel MOSFET MP6 has a source to which a first power voltage VDD is applied, a gate connected to the drain of the p-channel MOSFET MP5 and the gate of the p-channel MOSFET MP4, and a drain connected to a source of the p-channel MOSFET MP7. Further, the drain of the p-channel MOSFET MP6 is connected to a source of the n-channel MOSFET MN2 of the lower differential input terminal 120. The p-channel MOSFET MP7 has a source connected to the drain of the p-channel MOSFET MP6, a gate connected to the gate of the p-channel MOSFET MP5, and a drain connected to a driving block D2 and the switching terminal 150. Here, the p-channel MOSFET MP5 and p-channel MOSFET MP7 are biased by a bias voltage VBP1, and the drain voltage of the p-channel MOSFET MP5 is applied to the p-channel MOSFET MP4 and p-channel MOSFET MP6 as a bias voltage.

When a gate size of the p-channel MOSFET MP4 and a gate size of the p-channel MOSFET MP6 are equal to each other, and a gate size of the p-channel MOSFET MP5 and a gate size of the p-channel MOSFET MP7 are equal to each other, a current flowing through the p-channel MOSFET MP6 and p-channel MOSFET MP7 is equal to a current flowing through the p-channel MOSFET MP4 and p-channel MOSFET MP5. At this time, a saturation voltage of the p-channel MOSFET MP5 is higher than a threshold voltage (Vth) of the p-channel MOSFET MP4, thereby supplying current to the drain of the p-channel MOSFET MP7. Therefore, a range of an operating voltage is wider than that of a general structure of a current mirror.

When a current is applied at different values to each of the drains of the p-channel MOSFET MP4 and p-channel MOSFET MP6 due to the difference in the input voltage of the lower differential input terminal 1120, the final output current I (MP7) flowing through the p-channel MOSFET MP7 is determined by the bias current of +@IN by a bias voltage VBP1. Here, @ is a ratio of the current ‘In’ to a difference value of an input voltage obtained from the upper differential input terminal 1110 and the lower differential input terminal 1120, which are input stages of the current conveyor.

The lower current mirror stage 1140 includes an n-channel MOSFET MN4, an n-channel MOSFET MN5, an n-channel MOSFET MN6, and an n-channel MOSFET MN7 to define the current mirror. The n-channel MOSFET MN4 has a drain connected to a source of the n-channel MOSFET MN5, a gate connected to a gate of the n-channel MOSFET MN6, and a source to which a second power voltage VSS is applied. Further, the drain of the n-channel MOSFET MN4 is connected to the source of the p-channel MOSFET MP3 of the upper differential input terminal 1110. The n-channel MOSFET MN5 has a drain connected to the switching terminal 1150, a gate connected to a gate of the n-channel MOSFET MN7, and a source connected to the drain of the n-channel MOSFET MN4. Further, the source of the n-channel MOSFET MN5 is connected to the source of the p-channel MOSFET MP2 of the upper differential input terminal 1110. The n-channel MOSFET MN6 has a drain connected to a source of the n-channel MOSFET MN7, a gate connected to the gate of the n-channel MOSFET MN4, and a source to which a second power voltage VSS is applied. The n-channel MOSFET MN7 has a drain connected to the switching terminal 1150, a gate connected to the gate of the n-channel MOSFET MN5, and a source connected to the drain of the n-channel MOSFET MN6. Further, the drain of the n-channel MOSFET MN7 is connected to the source of the p-channel MOSFET MP2 of the upper differential input terminal 1110. Here, the n-channel MOSFET MN5 and n-channel MOSFET MN7 are biased with a bias voltage VBN1, and the source voltage of the n-channel MOSFET MN5 is applied as bias voltages of the n-channel MOSFET MN4 and n-channel MOSFET MN6.

When a gate size of the n-channel MOSFET MN4 and a gate size of the n-channel MOSFET MN6 are equal to each other, and a gate size of the n-channel MOSFET MN5 and a gate size of the n-channel MOSFET MN7 are equal to each other, a current flowing through the n-channel MOSFET MN6 and n-channel MOSFET MN7 is equal to a current flowing through the n-channel MOSFET MN4 and n-channel MOSFET MN5. At this time, a saturation voltage of the n-channel MOSFET MN5 is higher than a threshold voltage (Vth) of the n-channel MOSFET MN4, thereby supplying current to the drain of the n-channel MOSFET MN7. Therefore, a range of an operating voltage is wider than that of a general structure of a current mirror.

At this time, when current is applied at different values to each sources of the n-channel MOSFET MN4 and n-channel MOSFET MN6 due to the difference in the input voltage of the upper differential input terminal 1110, the final output current I (MN7) flowing through the n-channel MOSFET MN7 is determined by the bias current of +@IP by a bias voltage VBN1. Here, @ is a ratio of the current (Ip) to a difference value of an input voltage obtained from the upper differential input terminal 1110 and the lower differential input terminal 1120, which are input stages of the current conveyor.

In the present embodiment, the upper current mirror stage 1130 and the lower current mirror stage 1140 employ a high-compliance current mirror.

The driving block D2 includes a first driver 1210 and a second driver 1220, and outputs a normal output current through the ZP-port in response to the first driving voltage P_DRV and the second driving voltage N_DRV.

The first driver 1210 includes a p-channel MOSFET MP10 and an n-channel MOSFET MN10 connected in series. The p-channel MOSFET MP10 has a source to which a first power voltage VDD is applied, a gate connected to the upper current mirror terminal 1130, and a drain connected to a drain of the n-channel MOSFET MN10 and a drain connected to the X-port. The n-channel MOSFET MN10 has a source to which a second power voltage VSS is applied, a gate connected to the lower current mirror terminal 140, and a drain connected to a drain of the p-channel MOSFET MP10 and the X-port. The first driver 1210 performs the role of connecting the output to the X-port of the input stage to fit the structure of a second-generation current conveyor.

The second driver 1220 includes a p-channel MOSFET MP11 and an n-channel MOSFET MN11, which are serially connected in the same manner as the structure of the first driver 1210. The p-channel MOSFET MP11 has a source to which VDD is applied, a gate connected to the gate of the p-channel MOSFET MP10 of the first driver 1210, and a drain connected to both the drain of the n-channel MOSFET MN11 and the ZP port. The n-channel MOSFET MN11 has a source to which VSS is applied, a gate connected to both the gate of the lower current mirror terminal 1140 and the gate of the n-channel MOSFET MN10, and a drain connected to both the drain of the p-channel MOSFET MP11 and the ZP port. Unlike the first driver 1210, which is connected to the X port of the differential input stage of the upper differential input terminal 1110 and the lower differential input terminal 1120, the second driver 1220 is connected to the ZP port for output driving.

Referring back to FIG. 15, the first TX buffer ATX0 may be enabled in response to a first TX enable signal TX_EN[0], and may provide a first TX signal TX[0] to a first TX resistor RTX0. Similarly, the second TX buffer ATX1 may be enabled in response to a second TX enable signal TX_EN[1], and may provide a second TX signal TX[1] to a second TX resistor RTX1. The operating voltages of the first TX buffer ATX0 and the second TX buffer ATX1 may be supplied by a first power supply voltage VDD.

The first TX resistor RTX0 is disposed between the first TX buffer ATX0 and the X port of the current conveyor CC, such that the voltage level of the logic signal TX[0] may be readily converted into two types of currents applied to the X port of the current conveyor CC. Specifically, relative current values of −1 and +1, with respect to a reference value of 0 (corresponding to the logic signal voltage), may be applied to the X port of the current conveyor CC.

In addition, the second TX resistor RTX1 is disposed between the second TX buffer ATX1 and the X port of the current conveyor CC, such that the voltage level of the logic signal TX[1] may be readily converted into two types of currents applied to the X port of the current conveyor CC. Specifically, relative current values of −1 and +1, with respect to logic signal voltages of 0 and 1, may be applied to the X port of the current conveyor CC.

In the present embodiment, when the power of a logic core generating a transmission signal and the voltage of an interface power source for signal transmission are different from each other, or when different voltages should be used for communication signal quality, the first TX buffer ATX0 may use a buffer including a voltage level shifter. The operating voltage of the voltage level shifter is a VDD power supply voltage. In this case, when the value of the first TX resistor RTX0 is RTX, the voltage of the first TX buffer ATX0 is a first power voltage VDD, the common mode voltage VCOM is ½VDD, and the value of the first TX buffer ATX0 is 1, the current applied to the X-port of the current conveyor CC is shown in Equation (1) below.

$$I = \frac{( V DD - V COM )}{RTX} \qquad [ Equation 1 ]$$

On the other hand, when the value of the first TX buffer ATX0 is 0, the current applied to the X-port of the TX current conveyor TX_CC is shown in Equation (2) below.

$$I = \frac{( 0 - V COM )}{RTX} \qquad [ Equation 2 ]$$

Since the common mode voltage VCOM is equal to ½ VDD, the current values are (11/2 VDD) divided by RTX and −(11/2 VDD) divided by RTX, respectively. When expressed in relative magnitude, these currents correspond to +1 and −1, respectively.

When the first TX buffer ATX0 is disabled, its output is floated, and the current applied to the X port of the current conveyor CC becomes zero. In addition, the current supplied to the ZP port of the current conveyor CC is also zero. When this signal state is applied to the transmission line, the signal corresponds to a relative magnitude of zero.

As described above, an example has been provided in which the first TX signal TX[0] is applied to the X port of the current conveyor CC via the first TX buffer ATX0 and the first TX resistor RTX0, and converted into a current. Similarly, the second TX signal TX[1] may be applied to the X port of the current conveyor CC via the second TX buffer ATX1 and the second TX resistor RTX1, and converted into a current.

Referring to FIG. 15, two TX buffers and two resistors are configured within a DRV block to represent four relative magnitude current values. Similarly, when three or more TX buffers and three or more resistors are configured within a DRV block, a greater number of relative magnitude current values may be expressed. However, detailed description thereof is omitted herein.

Hereinafter, the DRV block 400 is described with reference to the current mode driver (DRV) circuit employing the current conveyor method, as shown in FIG. 15.

In FIG. 15, the RCV block 500 of the PHY unit may include a voltage generating part and a voltage comparator module configured for four transmission lines to receive PAM4 signals transmitted through the link unit.

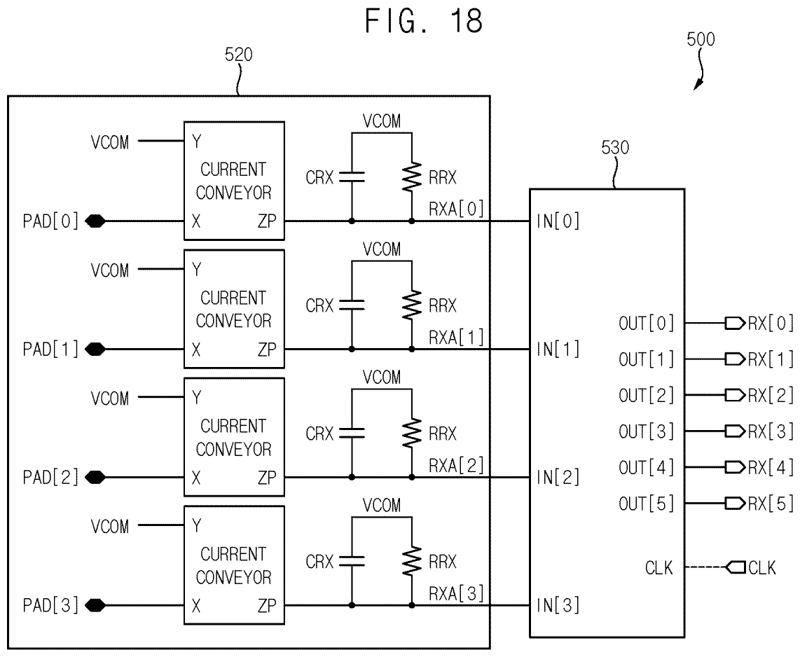

FIG. 17 is a circuit diagram for explaining an example of the RCV block shown in FIG. 12. In particular, an example of a voltage mode comparator circuit (Voltage Mode Comparator or OPAMP) is illustrated.

Referring to FIG. 17, the RCV block 500, according to an example, includes a voltage generating part 510 configured to convert the current of the PAM4 signal received through the transmission line into a voltage, and a voltage comparator module 530 configured to differentially compare the PAM4 signals converted into voltage by the voltage generating part 510.

The voltage generation unit 510 includes a plurality of RC parallel circuits disposed between the transmission line and the voltage comparator module 530. Each RC parallel circuit includes a resistor RRX and a capacitor CRX, wherein one end of each component is connected to a PAD connected to the transmission line, and the other end is connected to a common mode voltage or a common ground voltage. The resistor RRX converts the current of the PAM4 signal received through the transmission line into a voltage, while the capacitor CRX improves signal quality by bypassing high-frequency components or adjusting the frequency response. The capacitor CRX may perform high-frequency noise removal and equalization functions in conjunction with the resistor RRX.

Although FIG. 17 illustrates that the voltage generating part 510 includes a plurality of RC parallel circuits, the capacitor CRX connected between the PAD and the common mode voltage (or the common ground voltage) may be selectively employed. That is, the capacitor CRX may be omitted from the voltage generating part 510.

The voltage comparator module 530 includes six voltage comparators and differentially compares the PAM4 signals converted into voltages by the voltage generating part 510. A CLK input used in the voltage comparator module 530 may be selectively employed depending on the type of voltage comparator, if necessary.

Specifically, when the four transmission lines are designated as A, B, C, and D, each connected to PAD[0], PAD[1], PAD[2], and PAD[3] of the receiver, respectively, the voltage comparator module 530 compares the PAD signals as follows: RX[0]=(A−B), RX[1]=(B−C), RX[2]=(C−D), RX[3]=(D−A), RX[4]=(A−C), and RX[5]=(B−D). The resulting values RX[0] through RX[5] are output as input signals to the decoder circuit. In FIG. 17, A corresponds to PAD[0], B corresponds to PAD[1], C corresponds to PAD[2], and D corresponds to PAD[3].

The voltage comparator module 530 shown in FIG. 17 may include analog comparators or clock-based latch comparators configured to compare voltages at differential input terminals using current biasing.

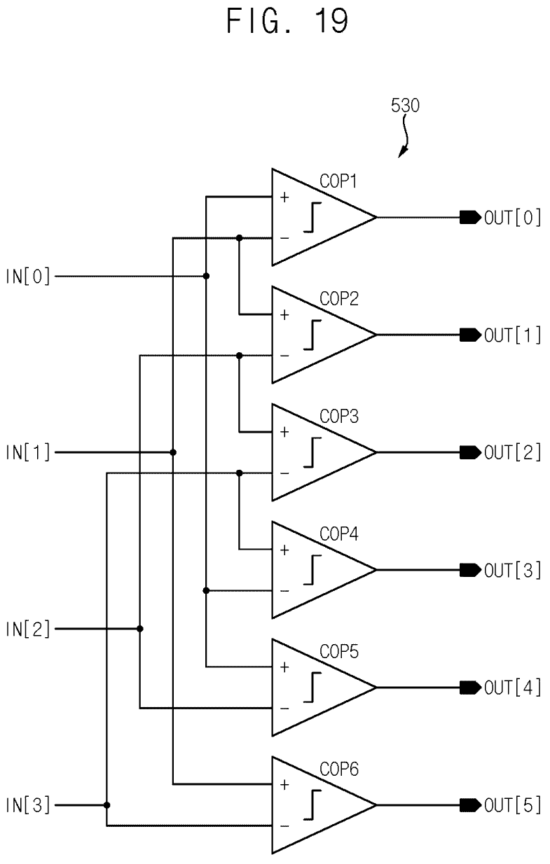

FIG. 18 is a circuit diagram for explaining another example of the RCV block 500 shown in FIG. 12. In particular, an example of a circuit using a comparator and an input of the X-port of the current conveyor CC is illustrated.

Referring to FIG. 18, the RCV block 500 according to another example includes a voltage generating part 520 that converts the current of the PAM4 signal provided through the transmission line into a voltage and a voltage comparator module 530 that differentially compares the PAM4 signals converted into voltage by the voltage generating part 520.

The voltage generating part 520 includes a plurality of current conveyor CC connected to the transmission line and a plurality of RC parallel circuits disposed between the current conveyor CC and the voltage comparator module 530.

Each of the current conveyors CC is connected to the four transmission lines of the link unit in a one-to-one manner.

Each of the RC parallel circuits includes a resistor RRX and a capacitor CRX having one end connected to the ZP-port of the current conveyor CC and the other end connected to the common mode voltage (or common ground voltage). The resistor RRX converts the current of the PAM4 signal provided through the ZP-port of the current conveyor CC into a voltage, and the capacitor CRX improves the signal quality by bypassing the high frequency component or adjusting the frequency response. The capacitor CRX may perform a high frequency noise removal and equalization function together with the resistor RRX.

Specifically, in order to generate the voltage value RXA[3:0] of the transmitted signal, the resistor RRX is disposed between the ZP-port of the current conveyor CC and the common mode voltage VCOM to convert the current, which is the transmitted signal, into a voltage. In addition, the capacitor CRX is disposed between the ZP-port of the current conveyor CC and the common mode voltage VCOM, and may operate as a manual filter for high-frequency noise removal or equalization in cooperation with the resistor RRX in the process of converting current into voltage.

Although FIG. 18 shows that the voltage generating part 520 includes a plurality of RC parallel circuits, the capacitor CRX connected between the PAD and the common mode voltage (or the common ground voltage) may be selectively used. That is, the capacitor CRX may be omitted from the voltage generating part 510.

The voltage comparator module 530 includes a comparator (or OPAMP) having six differential input terminals (Differential inputs) for RX signal classification from four RXA[3:0] outputs. When four transmission lines are named A, B, C, and D, and each transmission line is connected to PAD[0], PAD[1], PAD[2], and PAD[3] of the receiver, the voltage comparator module 530 compares the PAD signals of RX[0]=(A−B), RX[1]=(B−C), RX[2]=(C−D), RX[3]=(D−A), RX[4]=(A−C), and RX[5]=(B−D), respectively, and outputs the values of RX[0:5] as input values of the decoder circuit. Here, A denotes RXA[0], B denotes RXA[1], C denotes RXA[2], and D denotes RXA[3].

The CLK used in the voltage comparator module 530 may be selectively used depending on the type of the voltage comparator. The voltage comparator of the voltage comparator module 530 is a circuit that detects a difference between a differential signal, i.e., a positive input voltage and a negative input voltage and converts the difference into a digital signal (e.g., High(1) or Low(0)).

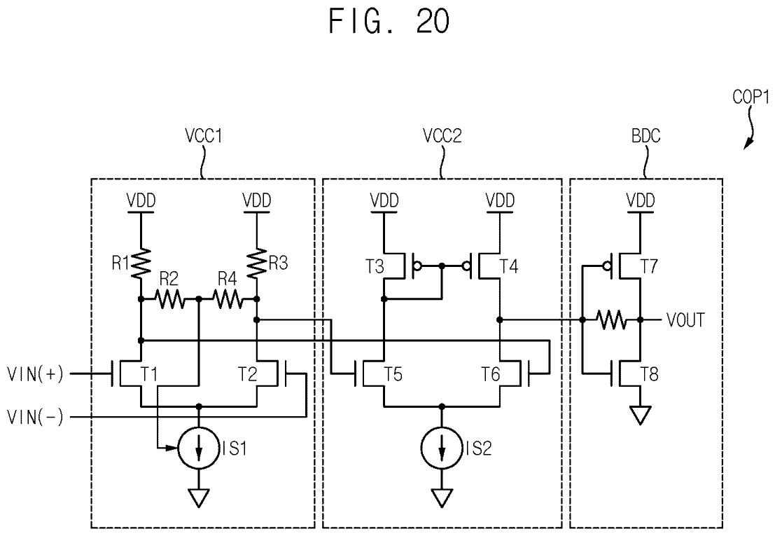

FIG. 19 is a circuit diagram for explaining an example of a voltage comparator shown in FIG. 17 or FIG. 18.

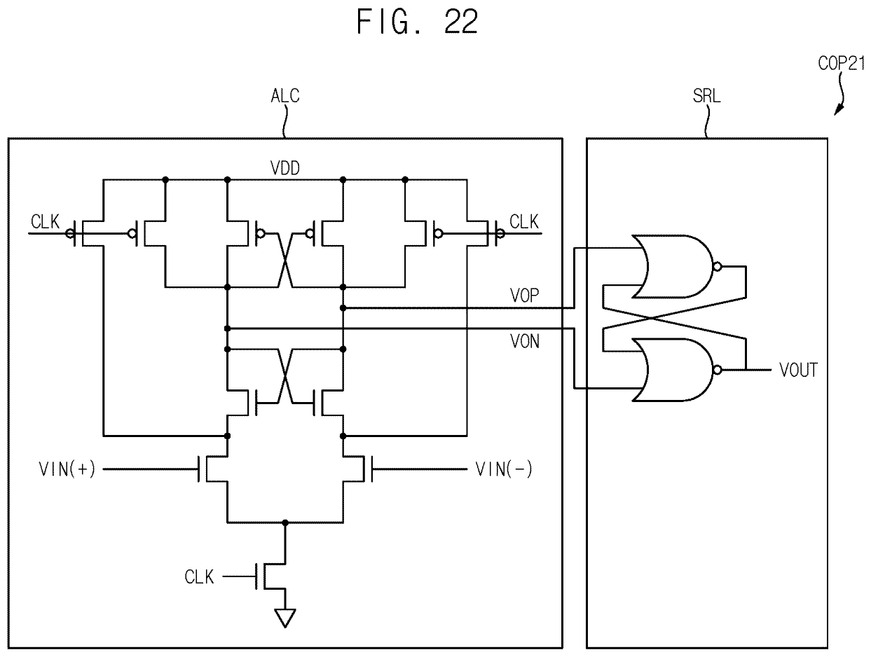

Referring to FIG. 19, a voltage comparator module 530 according to an embodiment includes a first differential voltage comparator COP1, a second differential voltage comparator COP2, a third differential voltage comparator COP3, a fourth differential voltage comparator COP4, a fifth differential voltage comparator COP5, and a sixth differential voltage comparator COP6. The voltage comparator module 530 is configured to differentially compare the voltage values RXA[3:0] of a signal transmitted from the voltage generating part 510 (see FIG. 18) and the voltage generating part 520 (see FIG. 21). The first through sixth voltage comparators COP1, COP2, COP3, COP4, COP5, and COP6 are differential comparators that receive a current bias and are configured to detect a voltage difference between input terminals of a gate.

The first differential voltage comparator COP1 outputs a first differential voltage OUT[0] by differentially comparing a first voltage IN[0] and a second voltage IN[1] provided from the voltage generating part 510:520. The second differential voltage comparator COP2 outputs a second differential voltage OUT[1] by differentially comparing the second voltage IN[1] and a third voltage IN[2] provided from the voltage generating part 510:520. The third differential voltage comparator COP3 outputs a third differential voltage OUT[2] by differentially comparing the third voltage IN[2] and a fourth voltage IN[3] provided from the voltage generating part 510:520. The fourth differential voltage comparator COP4 outputs a fourth differential voltage OUT[3] by differentially comparing the first voltage IN[0] and the fourth voltage IN[3] provided from the voltage generating part 510:520. The fifth differential voltage comparator COP5 outputs a fifth differential voltage OUT[4] by differentially comparing the first voltage IN[0] and the third voltage IN[2] provided from the voltage generating part 510:520. The sixth differential voltage comparator COP6 outputs a sixth differential voltage OUT[5] by differentially comparing the second voltage IN[1] and the fourth voltage IN[3] provided from the voltage generating part 510:520.

Data having specific bit values, as determined by an encoder and a decoder connected to four transmission lines, are transmitted and received as differential signals. Six differential voltage comparators are employed to receive signals by comparing the voltages input from the four transmission lines. In order to select and transmit a valid value that does not result in overlapping outputs from the differential voltage comparators, encoding logic (used during transmission) and decoding logic (used during reception) are required.

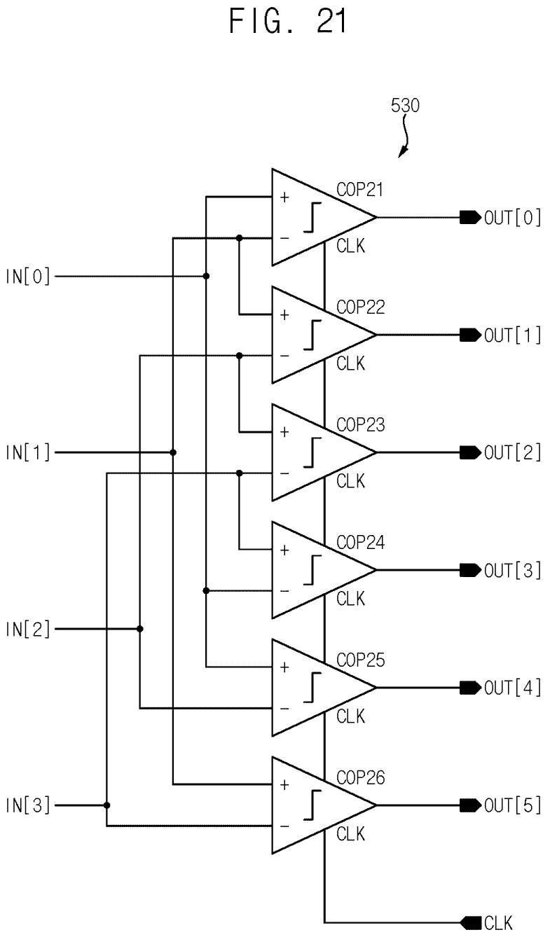

FIG. 20 is a circuit diagram for explaining a first differential voltage comparator of the voltage comparator module shown in FIG. 19. Although FIG. 20 illustrates a first differential voltage comparator, second to sixth differential voltage comparators have the same configuration.

Referring to FIG. 20, the first differential voltage comparator COP1 of the voltage comparator module 530 includes a first comparison circuit VCC1, a second comparison circuit VCC2, and a buffer driving circuit BDC. The comparator is configured to compare voltages at the differential voltage input terminals using a current bias.

The first comparison circuit VCC1 is connected to a current bias circuit configured to supply an operating current to the lower terminal of a field-effect transistor (FET) that receives a differential input.

The second comparison circuit VCC2 is configured to rapidly amplify the signal output from the first comparison circuit VCC1.

The buffer driving circuit BDC is connected to the second comparison circuit VCC2 and is configured to enhance high-speed operation and driving characteristics, even when a logic block with a large load is connected to the output terminal.

The output of the differential amplifier configured as described is influenced by the input voltages applied to VIN (+) and VIN (−), due to the common-drain connection of the transistors. Specifically, the drain currents of the two transistors are maintained such that the sum of the current flowing through transistor T1 and the current flowing through transistor T2 remains constant. As a result, the output voltages exhibit differential behavior, wherein an increase in the voltage on one side causes a corresponding decrease in the voltage on the opposite side.

FIG. 21 is a circuit diagram for explaining an example of a voltage comparator module shown in FIG. 17 or FIG. 18.

Referring to FIG. 21, the voltage comparator module 530 includes a first differential voltage comparator COP21, a second differential voltage comparator COP22, a third differential voltage comparator COP23, a fourth differential voltage comparator COP24, a fifth differential voltage comparator COP25, and a sixth differential voltage comparator COP26. These comparators operate in response to a clock signal (CLK) and are configured to differentially compare voltage values RXA[3:0] of a signal transmitted from the voltage generating part 510 (see FIG. 17 and FIG. 18). The first to sixth voltage comparators COP21, COP22, COP23, COP24, COP25, and COP26 are differential analog re-generative memory (ARM) latch voltage comparators with latches that detect differences between input voltages of gates using comparison clocks.

The first differential voltage comparator COP21 outputs a first differential voltage OUT[0] by differentially comparing a first voltage IN[0] and a second voltage IN[1] provided from the voltage generating part 510:520 in response to a clock signal CLK. The second differential voltage comparator COP22 outputs a second differential voltage OUT[1] by differentially comparing the second voltage IN[1] and a third voltage IN[2] provided from the voltage generating part 510:520 in response to the clock signal CLK. Similarly, the third differential voltage comparator COP23 outputs a third differential voltage OUT[2] by differentially comparing the third voltage IN[2] and a fourth voltage IN[3] provided from the voltage generating part 510:520 in response to the clock signal CLK. The fourth differential voltage comparator COP24 outputs a fourth differential voltage OUT[3] by differentially comparing the first voltage IN[0] and the fourth voltage IN[3] provided from the voltage generating part 510:520 in response to the clock signal CLK. Furthermore, the fifth differential voltage comparator COP25 outputs a fifth differential voltage OUT[4] by differentially comparing the first voltage IN[0] and the third voltage IN[2] provided from the voltage generating part 510-520 in response to the clock signal CLK. The sixth differential voltage comparator COP26 outputs a sixth differential voltage OUT[5] by differentially comparing the second voltage IN[1] and the fourth voltage IN[3] provided from the voltage generating part 510:520 in response to the clock signal CLK.

Data corresponding to specific bit values, as defined by the encoder and decoder for the four transmission lines, are transmitted and received as differential signals. Six differential voltage comparators, which compare signals received from the four transmission lines, are used to obtain reception signals. An encoding logic, employed during transmission, and a decoding logic, employed during reception, are required to select and process valid values that do not overlap within the output results of the differential voltage comparators.

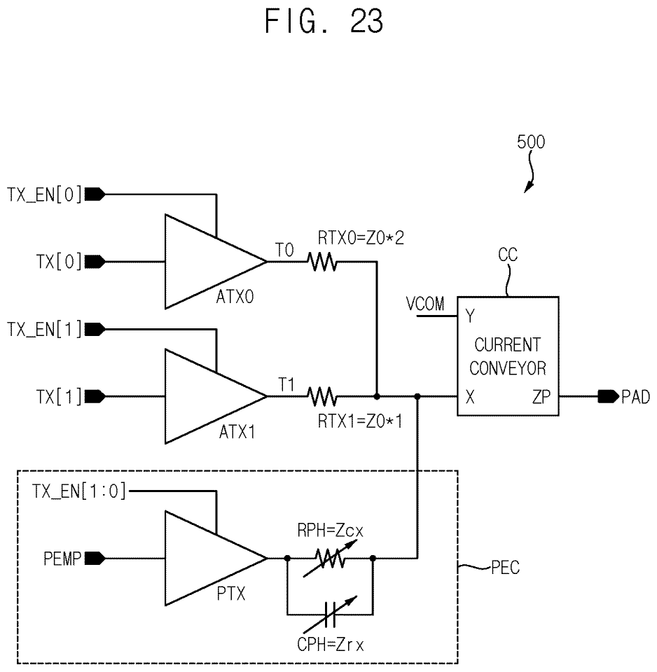

FIG. 22 is a circuit diagram for explaining a first differential voltage comparator of the voltage comparator module shown in FIG. 21.

Referring to FIG. 22, the first differential voltage comparator COP21 is a circuit in which a differential voltage comparator ALC and an SR-latch SRL operate together, and detects a difference between input voltages of a gate using a comparison clock. The first differential voltage comparator COP21 includes a differential analog re-generative memory (ARM) latch voltage comparator.

The differential voltage comparator (ALC) compares the two input signals to determine the output signal, amplifying the difference between VIN (+) and VIN (−) and determining the output signal based on the amplified difference.

When an output of the differential voltage comparator ALC is determined, the SR-latch SRL stores the output state. The output of the SR-latch SRL stores an output state of the differential voltage comparator ALC and maintains the stored state for a predetermined period of time.

Since a bias voltage (or current) is not separately required, unlike comparators employing the bias application method described above, power consumption is significantly reduced, which is advantageous for systems where low power consumption is critical, as in the present invention. Furthermore, the time required to obtain the comparison result for the input signal is relatively short, thereby enabling high-speed operation. The comparison result is promptly output in response to the comparison clock or trigger signal, allowing accurate control of sampling timing. In addition, the differential voltage comparator is configured such that a comparison value is generated and updated only at the rising edge (or falling edge) of the comparison clock or trigger signal by connecting an SR latch to both output terminals of the ARM latch voltage comparator.

In the detailed embodiments of this specification, the RCV block is described based on a differential ARM latch voltage comparator configured to detect differences in the input gate voltages using a comparison clock, as shown in the above circuit.

In the present invention, when a PAM4 signal is transmitted and received through a link unit comprising four transmission lines, the maximum number of symbols used in communication is 24 (refer to the value shown in Table 4 above).

As described above, the sum of the values of the PAM4 signals applied to the four transmission lines is zero. Accordingly, regardless of which symbol among the 24 is transmitted, the sum of the energy values required to drive the corresponding symbol on the transmission lines is zero. Here, the energy value is calculated by considering the energy consumed from VDD as a positive value and the energy consumed from GND as a negative value.

Therefore, since the signals applied to the four transmission lines are configured to have complementary values with opposite polarities on different transmission lines, the electromagnetic energy emitted from the transmission lines is mutually offset. As a result, electromagnetic interference (EMI) emission is significantly reduced without requiring separate ground shield wiring.

In addition, since signals transmitted through the four transmission lines (link units) are transmitted in a form capable of being divided into differential signals, the signal-to-noise ratio (SNR) of the communication signals is superior to that of a single-ended method in which signals are independently transmitted on each transmission line, as in the comparative example. Consequently, the signals exhibit reduced jitter and skew characteristics.

In addition, all 24 symbols exhibit the same current consumption on the transmission lines regardless of the symbol, thereby minimizing the difference between average power consumption during data transmission and the peak-to-peak power consumption (maximum power consumption minus minimum power consumption). This reduces the complexity of the power supply system and enables uniform control of the total energy cross-coupled on the transmission lines, facilitating link design and improving overall bit error rate (BER).

The present invention can be applied by reducing the number of link units used through utilization of the surplus symbols, thereby maximizing the data transmission capacity using all conventional link units. Additionally, certain symbols (e.g., start, end, idle status) may be designated for control purposes or for monitoring the transmission lines (e.g., error correction signals, error detection signals, quality improvement signals), since link units employing comparative NRZ signal formats can represent a greater number of symbols than those required solely for data transmission.

As a method for improving the quality of the transmission lines, calibration is performed on the driving values and reception values of the PHY unit, taking into account the load conditions of each transmission line. This is achieved by designating a specific value among predefined signal control methods or symbol display values. The calibration is conducted both during signal transmission and data reception of the PHY unit as follows.

The DRV block of the PHY unit transmitting data on one side optimizes driving characteristics to minimize signal jitter and maximize eye pattern area through pre-emphasis. Meanwhile, the RCV block of the opposing PHY unit performs a series of operations to enhance communication quality by measuring and adjusting data timing, as well as improving received signal sensitivity through adaptive equalization processing.

The pre-emphasis used in the present invention compensates for high-frequency attenuation occurring in the transmission channel by emphasizing the high-frequency components of the signal at the transmitting end. In particular, it addresses the attenuation of high-frequency components caused by high data rates. Typically, the signal intensity is temporarily increased during data intervals with large signal transitions, while in data intervals with small signal changes, the signal amplitude is reduced. This adjustment serves to compensate for signal attenuation occurring along the transmission line.

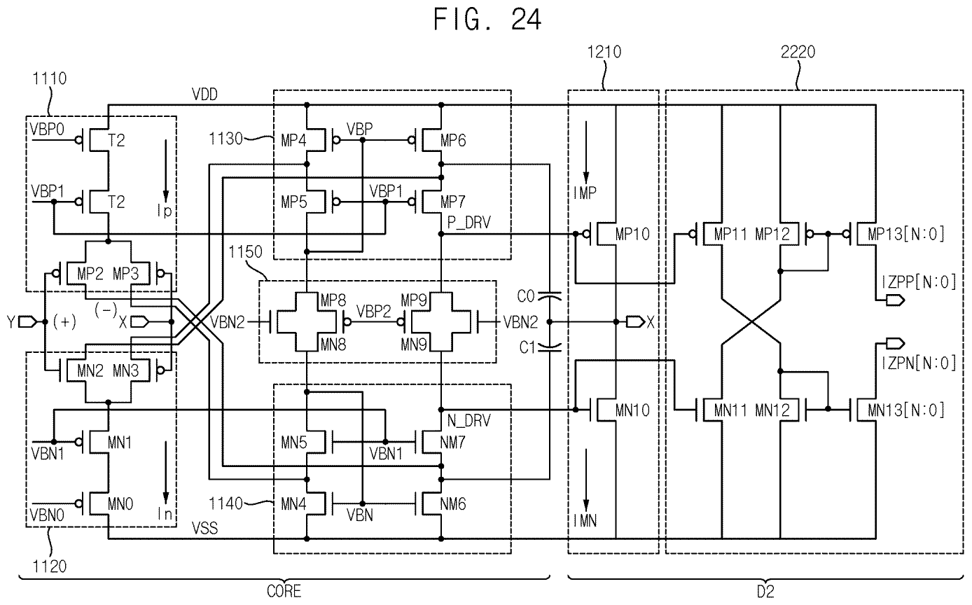

FIG. 23 is a circuit diagram for explaining another example of the DRV block shown in FIG. 12. In particular, a DRV block including a pre-emphasis circuit is illustrated in the DRV block illustrated in FIG. 15.

Referring to FIG. 23, the DRV block 500 according to another example includes a first TX buffer ATX0, a first TX resistor RTX0, a second TX buffer ATX1, a second TX resistor RTX1, a pre-emphasis circuit PEC, and a current conveyor CC, and converts the voltage signal input from the outside into a current signal and provides the converted current signal to the transmission line through the I/O pad.

The first TX resistor RTX0 and the second TX resistor RTX1 may have resistance values in the range of 300 to 10 kΩ. Alternatively, the first TX resistor RTX0 and the second TX resistor RTX1 may be set to resistance values for generating a current between 50 μA and 300 μA as a data transmission signal according to a voltage VDD of an output circuit.

The first TX buffer ATX0, the first TX resistor RTX0, the second TX buffer ATX1, the second TX resistor RTX1, and the current conveyor CC shown in FIG. 23 have been described in FIG. 15, so the same reference numerals are given and the detailed description thereof is omitted.

The pre-emphasis circuit PEC includes a pre-emphasis buffer PTX, which is enabled by TX_EN[1:0] to buffer a pre-emphasis signal, a variable resistor RPH, and a variable capacitor CPH. The pre-emphasis circuit PEC temporarily increases or decreases an intensity of the TX signal applied to the X-port of the current conveyor CC. Here, the variable resistor RPH and the variable capacitor CPH may improve signal characteristics at the reception side by applying artificial distortion to the TX signal. In the present exemplary embodiment, at least one of the variable resistor RPH and the variable capacitor CPH may be omitted.

The number of pre-emphasis circuits PEC may be one or more per single transmission line. A degree of distortion caused by the pre-emphasis circuit PEC may be variably adjusted according to the characteristics of the transmission line. Here, the characteristics of the transmission line may include a frequency response characteristic, an impedance of the transmission line, a cross-coupling characteristic with respect to an adjacent signal, and the like.

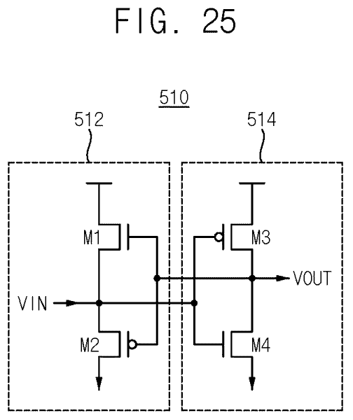

FIG. 24 is a circuit diagram for explaining another example of the current conveyor shown in FIG. 15.

Referring to FIG. 24, the current conveyor CC includes a core block CORE and a driving block D2.

Since the core block CORE is the same as the core block CORE shown in FIG. 16, the same reference numerals are given and the detailed description thereof is omitted.

The driving block D2 includes a first driver 1210 and a second driver 2220, and outputs a first normal output current and a second normal output current through the first ZP-port IZPP and the second ZP-port IZPN in response to the first driving voltage P_DRV and the second driving voltage N_DRV.

The first driver 1210 may be composed of a p-channel MOSFET MP10 and an n-channel MOSFET MN10 connected in series. The p-channel MOSFET MP10 has a source to which the first power supply voltage VDD is applied, a gate connected to the upper current mirror terminal 1130, and a drain of the n-channel MOSFET MN10 and a drain connected to the X-port. The n-channel MOSFET MN10 has a source to which a second power supply voltage VSS is applied, a gate connected to a lower current mirror terminal 1140 and a drain of the p-channel MOSFET MP10 and the X-port. The first driver 1210 serves to connect the output to the X-port of the input stage to suit the structure of the second generation current conveyor.

The second driver 2220 may include a p-channel MOSFET MP11 and an n-channel MOSFET MN11, which are connected in series to p-channel MOSFET MN11 and n-channel MOSFET MN11 which are connected to the first ZP-port IZPP to output the first normal output current, and n-channel MOSFET MN12 and n-channel MOSFET MN13 which are connected to the p-channel MOSFET MP11 and output the second normal output current through the second ZP-port IZPN.

The p-channel MOSFET MP11 has a source to which a VDD is applied, a gate commonly connected to the gate of the upper current mirror terminal 1130 and the gate of the p-channel MOSFET MP10, and a drain connected to the source of the n-channel MOSFET MN12. The n-channel MOSFET MN11 has a source to which a VSS is applied, a gate commonly connected to the gate of the lower current mirror terminal 1140 and the gate of the n-channel MOSFET MN10, and a drain connected to the drain of the p-channel MOSFET MP12.

The p-channel MOSFET MP12 has a source to which the VDD is applied, a gate and a drain commonly connected to the source of the n-channel MOSFET MN11. The p-channel MOSFET MP13 has a source to which the VDD is applied, a gate of the p-channel MOSFET MP12, and a drain connected to the first ZP-port. The p-channel MOSFET MP12 and the p-channel MOSFET MP13 function as a current mirror to source a current.

The n-channel MOSFET MN12 has a source connected to the drain of the p-channel MOSFET MP11, a gate connected in common to the source, and a drain connected to the drain of the p-channel MOSFET MP11, and a drain connected to the VSS. The n-channel MOSFET MN13 has a source connected to the second ZP-port, a gate connected to the gate of the n-channel MOSFET MN12, and a drain connected to the VSS. The n-channel MOSFET MN12 and the n-channel MOSFET MN13 function as a current mirror to sink the current.

The first driver 1210 is connected to the X-port of the differential input stage of the upper differential input terminal 1110 and the lower differential input terminal 1120, but the second driver 2220 is connected to the first ZP-port IZPP and the second ZP-port IZPN for output driving.

In FIG. 17, the voltage generating part 510 that generates an output voltage based on the mirrored current of the ZP-port, which is the output of the current conveyor, is composed of an RC parallel circuit, but the voltage generating part 510 may be configured by the resistance element alone.

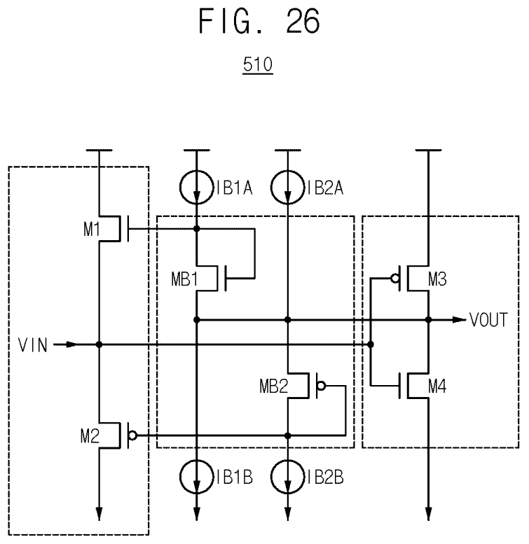

FIG. 25 is a circuit diagram for explaining an example of the voltage generating part shown in FIG. 17.

Referring to FIG. 25, the voltage generating part 510 includes a source follower 512 comprising a first NMOS M1 and a first PMOS M2 to which gates are commonly connected, and a CMOS inverter 514 comprising a second PMOS M3 and a second NMOS M4 to which gates are commonly connected.

The first n-channel MOSFET M1 has a drain coupled to a power supply voltage, a gate coupled to the gate of the first p-channel MOSFET M2, and a source coupled to the drain of the first p-channel MOSFET M2. The first p-channel MOSFET M2 has a drain coupled to the source of the first n-channel MOSFET M1, a gate coupled to the gate of the first n-channel MOSFET M1, and a source coupled to a ground power source. The source of the first n-channel MOSFET M1 and the drain of the first p-channel MOSFET M2 are commonly connected to receive an input current lin. The gates of the first n-channel MOSFET M1 and the first p-channel MOSFET M2 are commonly connected to output an output voltage Vout.

The second p-channel MOSFET M3 has a drain coupled to a power supply voltage, a gate coupled to the gate of the second n-channel MOSFET M4, and a source coupled to the drain of the second n-channel MOSFET M4. The second n-channel MOSFET M4 has a drain coupled to the source of the second p-channel MOSFET M3, a gate coupled to the gate of the second p-channel MOSFET M3, and a source coupled to a ground power source. The source of the second p-channel MOSFET M3 and the drain of the second n-channel MOSFET M4 are commonly connected to output an output voltage Vout.

The input current I in represents a differential input current, and the output voltage Vout is amplified by the subsequent CMOS inverter, which includes transistors M3 and M4, and is output as a rail-to-rail signal.

In this embodiment, the voltage generating part 510 employs source followers M1 and M2 as input stages and CMOS inverters M3 and M4 as positive feedback elements. This configuration reduces input resistance and shortens response time compared to conventional voltage generating parts based on current mirrors.

Meanwhile, during dynamic response to a small input current, a temporary deadband region may occur in which both input transistors M1 and M2 are turned off, resulting in increased input resistance. Consequently, as the input current decreases, the dynamic response time of the voltage generating part 510 significantly increases.

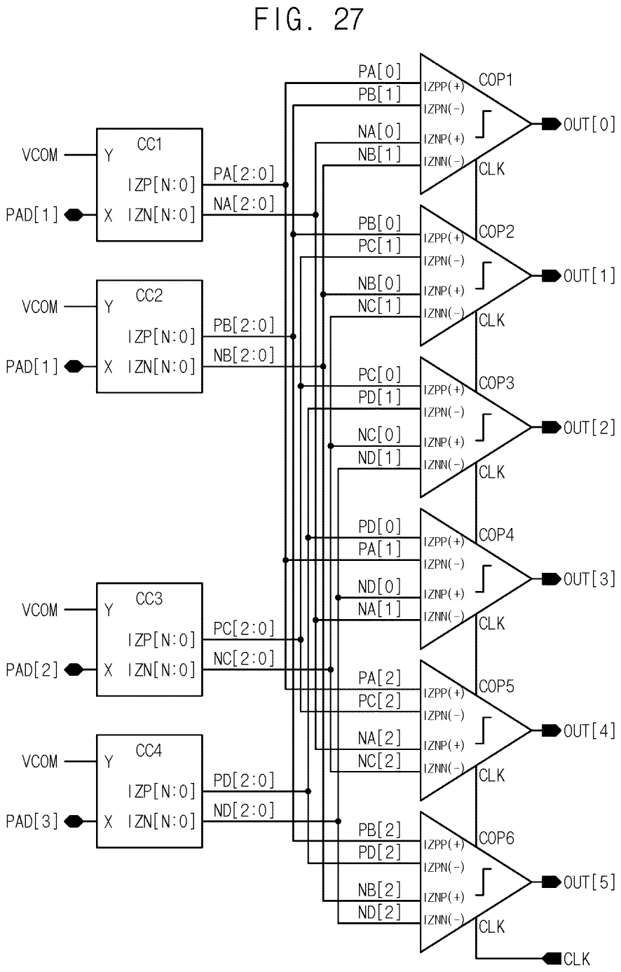

FIG. 26 is a circuit diagram for explaining another example of the voltage generating part shown in FIG. 17.

Referring to FIG. 26, the voltage generating part 510 includes source followers M1 and M2, diode operation transistors MB1 and MB2, four current sources IB1A, IB1B, IB2A, and IB2B for a bias circuit, and CMOS inverters M3 and M4.

The voltage generating part 510 illustrated in FIG. 26 modifies the biasing method of the input stage from class B operation to class AB operation. Accordingly, two diode-connected transistors MB1 and MB2 are added compared to the voltage generating part 510 illustrated in FIG. 19. As a result, a deadband region is reduced, thereby improving a response time for small input currents.

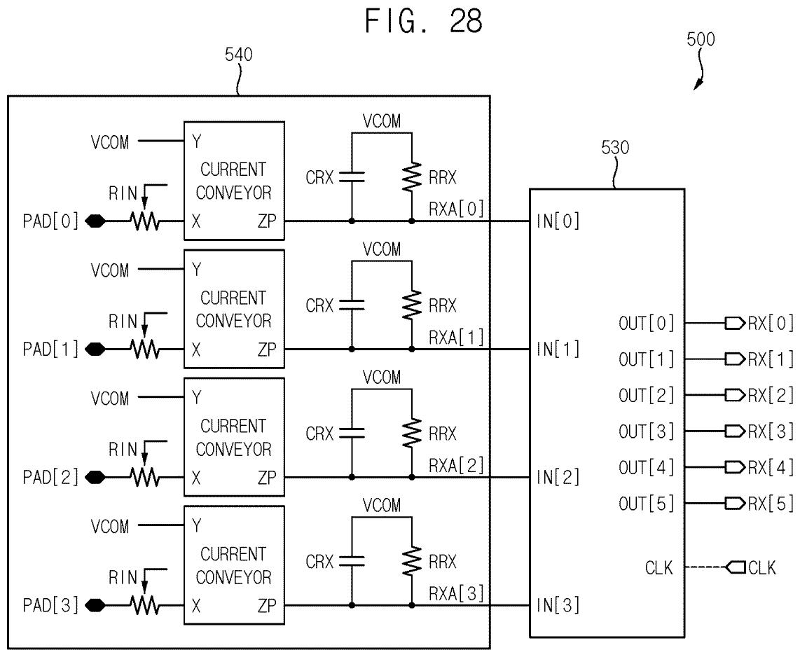

FIG. 27 is a circuit diagram for explaining another example of the RCV block shown in FIG. 12. In particular, a circuit diagram of an RCV block configured to include the current conveyor shown in FIG. 17 is illustrated.

Referring to FIG. 27, the RCV block includes a first current conveyor CC1, a second current conveyor CC2, a third current conveyor CC3, a fourth current conveyor CC4, a first differential current comparator COP1, a third differential current comparator COP3, a fourth differential current comparator COP4, a fifth differential current comparator COP5, and a sixth differential current comparator COP6.

The first current conveyor CC1 includes an X-port, to which a current is applied via connection to the first pad PAD[0], a Y-port, to which a common-mode voltage VCOM from the transmission line is applied, a first ZP-port IZP for mirroring and outputting the first normal output current, and a second ZP-port IZN for mirroring and outputting the second normal output current. The first ZP-port IZP and the second ZP-port IZN of the first current conveyor CC1 are connected to the first differential current comparator COP1, the fourth differential current comparator COP4, and the fifth differential current comparator COP5, respectively, to output the mirrored currents.

The second current conveyor CC2 includes an X-port, to which current is applied via connection to the second pad PAD[1], a Y-port, to which a common-mode voltage VCOM from the transmission line is applied, a first ZP-port IZP for mirroring and outputting the first normal output current, and a second ZP-port IZN for mirroring and outputting the second normal output current. The first ZP-port IZP and the second ZP-port IZN of the second current conveyor CC2 are connected to the first differential current comparator COP1, the second differential current comparator COP2, and the fifth differential current comparator COP5, respectively, to output the mirrored currents.

The third current conveyor CC3 includes an X-port, to which current is applied via connection to the third pad PAD[2], a Y-port, to which a common-mode voltage VCOM from the transmission line is applied, a first ZP-port IZP for mirroring and outputting the first normal output current, and a second ZP-port IZN for mirroring and outputting the second normal output current. The first ZP-port IZP and the second ZP-port IZN of the third current conveyor CC3 are connected to the second differential current comparator COP2, the third differential current comparator COP3, and the fifth differential current comparator COP5, respectively, to output the mirrored currents.

The fourth current conveyor CC4 includes an X-port, to which current is applied via connection to the fourth pad PAD[3], a Y-port, to which a common-mode voltage VCOM from the transmission line is applied, a first ZP-port IZP for mirroring and outputting the first normal output current, and a second ZP-port IZZN for mirroring and outputting the second normal output current. The first ZP-port IZP and the second ZP-port IZZN of the fourth current conveyor CC4 are connected to the third differential current comparator COP3, the fourth differential current comparator COP4, and the sixth differential current comparator COP6, respectively, to output the mirrored currents.

The first differential current comparator COP1 outputs a first differential current OUT[0] by differentially comparing the first and second normal output currents provided by the first current conveyor CC1 with the first and second normal output currents provided by the second current conveyor CC2, in response to the clock signal.

The second differential current comparator COP2 outputs a second differential current OUT[1] by differentially comparing the first and second normal output currents provided by the second current conveyor CC2 with the first and second normal output currents provided by the third current conveyor CC3, in response to the clock signal.

The third differential current comparator COP3 outputs a third differential current OUT[2] by differentially comparing the first and second normal output currents provided by the third current conveyor CC3 with the first and second normal output currents provided by the fourth current conveyor CC4, in response to the clock signal.

The fourth differential current comparator COP4 outputs a fourth differential current OUT[3] by differentially comparing the first and second normal output currents provided by the first current conveyor CC1 with the first and second normal output currents provided by the fourth current conveyor CC4, in response to the clock signal.

The fifth differential current comparator COP5 outputs a fifth differential current OUT[4] by differentially comparing the first and second normal output currents provided by the first current conveyor CC1 with the first and second normal output currents provided by the third current conveyor CC3, in response to the clock signal.

The sixth differential current comparator COP6 outputs a sixth differential current OUT[5] by differentially comparing the first and second normal output currents provided by the second current conveyor CC2 with the first and second normal output currents provided by the fourth current conveyor CC4, in response to the clock signal.

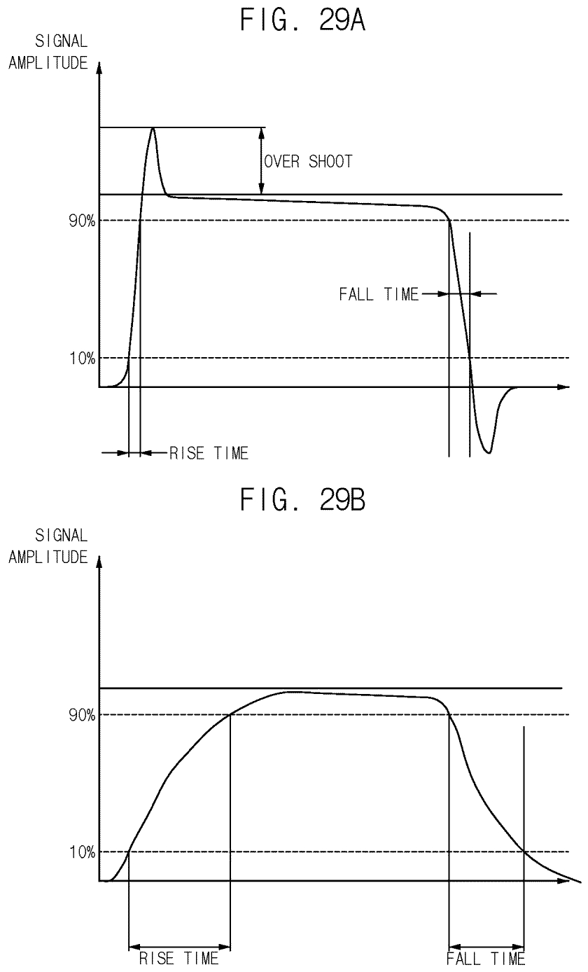

FIG. 28 is a circuit diagram for explaining another example of the RCV block shown in FIG. 12.

Referring to FIG. 28, an RCV block 500 according to another embodiment includes a voltage generating part 540 configured to convert the current of the PAM4 signal provided through a transmission line into a voltage, and a voltage comparator module 530 configured to differentially compare PAM4 signals that have been converted into voltages by the voltage generating part 540. As the voltage comparator module 530 illustrated in FIG. 28 is identical to the voltage comparator module 530 illustrated in FIG. 18, identical reference numerals are used, and a detailed description thereof is omitted.

The voltage generating part 540 includes a plurality of variable resistors Rin, one end of which is connected to the transmission line, a plurality of current conveyors CC connected to the other end of the variable resistors Rin, and a plurality of RC parallel circuits disposed between the current conveyors CC and the voltage comparator module 530. Since the current conveyors CC and the RC parallel circuits shown in FIG. 28 are identical to those shown in FIG. 18, the same reference numerals are used, and detailed descriptions thereof are omitted. Additionally, the RCV block 500 shown in FIG. 28 further includes variable resistors between the pad and the X-port of the current conveyor, in contrast to the RCV block 500 shown in FIG. 18.

The use of the variable resistor Rin, specifically the reason for including a variable resistor at the X-port for impedance matching, is as follows:

In order to receive the current transmitted from the DRV block, the current conveyor of the RCV block drives a current that is opposite in direction to the current transmitted to the X-port. At this point, if the impedance of the transmission line matches the output impedance of the X-port, the received signal can achieve optimal rise time and polling time without overshooting or undershooting, thereby improving communication quality.

A transmission line, which may include PCB, TSV, wire, or other configurations, can vary in shape, length, and design conditions. As a result, the impedance of the transmission line may differ. Therefore, it is necessary to match or equalize the output impedance of the X-port of the RCV block, which serves as the receiving end, with the impedance of the transmission line.

For impedance matching, the present invention inserts a variable resistor, which is adjustable to change and set the resistance value, between the PAD of the RCV block (the receiving end) and the X-port of the current conveyor.

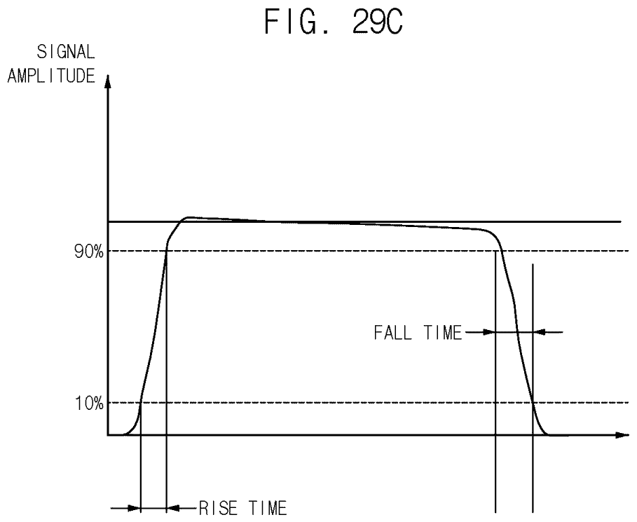

FIG. 29A, FIG. 29B, and FIG. 29C are graphs showing a signal amplitude according to an output impedance of the X-port of the RCV block shown in FIG. 28. In particular, FIG. 29A shows a graph of a waveform when the output impedance of the X-port of the RCV block shown in FIG. 28 is low, FIG. 29B shows a graph of a waveform when the output impedance of the RCV X-port of the RCV block shown in FIG. 28 is high, and FIG. 29C shows a graph of a waveform when the output impedance of the RCV X-port of the RCV block shown in FIG. 28 is appropriate.

Referring to FIG. 29A, when the output impedance of the X-port is less than the impedance of the transmission line, waveforms of the overshoot and the undershoot interrupting the communication are generated. In this case, by increasing the resistance value of Rin to control the output impedance of the X-port to match the impedance of the transmission line, a signal waveform used for stable communication as illustrated in FIG. 29C may be generated.

Referring to FIG. 29B, when the output impedance of the X-port is greater than the impedance of the transmission line, there is no overshoot or undershoot, but the rising time and the polling time are large. In this case, by reducing the resistance value of Rin and controlling the output impedance of the X-port to match the impedance of the transmission line, the optimum rising time and polling time as shown in FIG. 29C may be guaranteed, and thus a signal waveform used for stable communication may be generated.

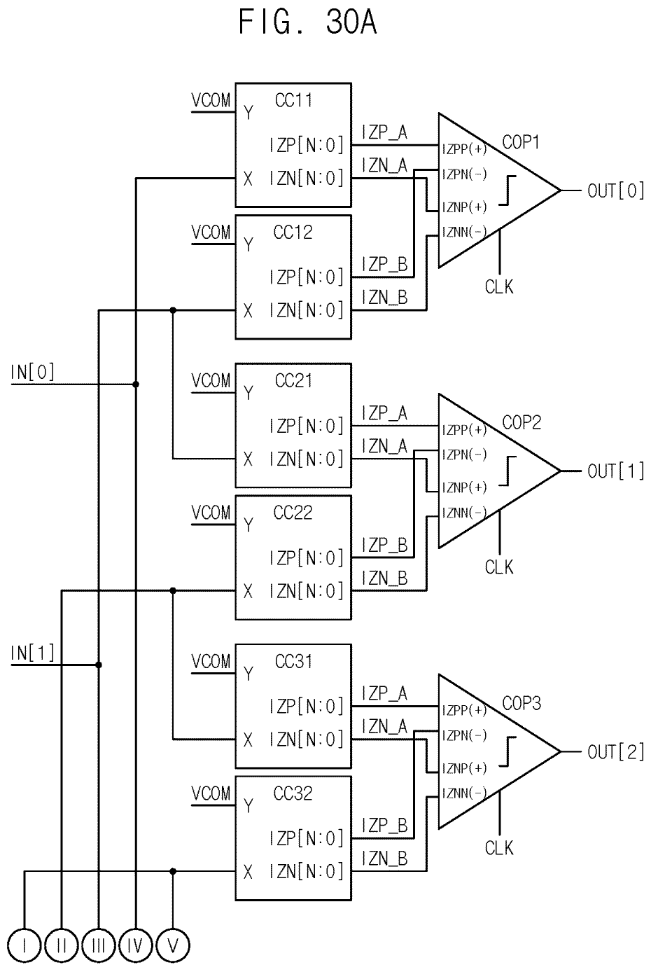

FIG. 30A and FIG. 30B are circuit diagrams illustrating another example of the current comparator module shown in FIG. 17 or FIG. 18.

Referring to FIG. 30A and FIG. 30B, the RCV block includes a first current conveyor CC11, a second current conveyor CC12, a third current conveyor CC21, a fourth current conveyor CC22, a fifth current conveyor CC31, a sixth current conveyor CC32, a seventh current conveyor CC41, an eighth current conveyor CC42, a ninth current conveyor CC51, a tenth current conveyor CC52, a eleventh current conveyor CC61, a twelfth current conveyor CC62, a first differential current comparator COP1, a second differential current comparator COP2, a third differential current comparator COP3, a fourth differential current comparator COP4, a fifth differential current comparator COP5, and a sixth differential current comparator COP6.

The first current conveyor CC11 includes an X-port to which current is applied by being connected to the first pad IN[0], a Y-port to which a common mode voltage VCOM on a transmission line is applied, a first ZP-port IZP that mirrors a first normal output current and outputs it to the first differential current comparator COP1, and a second ZP-port IZN that mirrors a second normal output current and outputs it to the first differential current comparator COP1.

The second current conveyor CC12 includes an X-port connected to the second pad IN[1] to which current is applied, a Y-port to which a common mode voltage VCOM on a transmission line is applied, a first ZP-port IZP that mirrors a first normal output current and outputs it to the first differential current comparator COP1, and a second ZP-port IZN that mirrors a second normal output current and outputs it to the first differential current comparator COP1.

The third current conveyor CC21 includes an X-port connected to the second pad IN[1] to which current is applied, a Y-port to which a common mode voltage VCOM on a transmission line is applied, a first ZP-port IZP that mirrors a first normal output current and outputs it to the second differential current comparator COP2, and a second ZP-port IZN that mirrors a second normal output current and outputs it to the second differential current comparator COP2.

The fourth current conveyor CC22 includes an X-port to which current is applied by being connected to the third pad IN[2], a Y-port to which a common mode voltage VCOM on a transmission line is applied, a first ZP-port IZP that mirrors a first normal output current and outputs it to the second differential current comparator COP2, and a second ZP-port IZN that mirrors a second normal output current and outputs it to the second differential current comparator COP2.

The fifth current conveyor CC31 includes an X-port to which current is applied by being connected to the third pad IN[2], a Y-port to which a common mode voltage VCOM on a transmission line is applied, a first ZP-port IZP that mirrors a first normal output current and outputs it to the third differential current comparator COP3, and a second ZP-port IZN that mirrors a second normal output current and outputs it to the third differential current comparator COP3.

The sixth current conveyor CC32 includes an X-port connected to the fourth pad IN[3] to which current is applied, a Y-port to which a common mode voltage VCOM on a transmission line is applied, a first ZP-port IZP that mirrors a first normal output current and outputs it to the third differential current comparator COP3, and a second ZP-port IZN that mirrors a second normal output current and outputs it to the third differential current comparator COP3.

The seventh current conveyor CC41 includes an X-port to which current is applied by being connected to the third pad IN[2], a Y-port to which a common mode voltage VCOM on a transmission line is applied, a first ZP-port IZP that mirrors a first normal output current and outputs it to the fourth differential current comparator COP4, and a second ZP-port IZN that mirrors a second normal output current and outputs it to the fourth differential current comparator COP4.

The eighth current conveyor CC42 includes an X-port to which current is applied by being connected to the first pad IN[0], a Y-port to which a common mode voltage VCOM on a transmission line is applied, a first ZP-port IZP that mirrors a first normal output current and outputs it to the fourth differential current comparator COP4, and a second ZP-port IZN that mirrors a second normal output current and outputs it to the fourth differential current comparator COP4.

The ninth current conveyor CC51 includes an X-port to which current is applied by being connected to the first pad IN[0], a Y-port to which a common mode voltage VCOM on a transmission line is applied, a first ZP-port IZP that mirrors a first normal output current and outputs it to the fifth differential current comparator COP5, and a second ZP-port IZN that mirrors a second normal output current and outputs it to the fifth differential current comparator COP5.

The tenth current conveyor CC52 includes an X-port to which current is applied by being connected to the third pad IN[2], a Y-port to which a common mode voltage VCOM on a transmission line is applied, a first ZP-port IZP that mirrors a first normal output current and outputs it to the fifth differential current comparator COP5, and a second ZP-port IZN that mirrors a second normal output current and outputs it to the fifth differential current comparator COP5.

The eleventh current conveyor CC61 includes an X-port connected to the second pad IN[1] to which current is applied, a Y-port to which a common mode voltage VCOM on a transmission line is applied, a first ZP-port IZP that mirrors a first normal output current and outputs it to the sixth differential current comparator COP6, and a second ZP-port IZN that mirrors a second normal output current and outputs it to the sixth differential current comparator COP6.

The twelfth current conveyor CC62 includes an X-port connected to the third pad IN[2] to which current is applied, a Y-port to which a common mode voltage VCOM on a transmission line is applied, a first ZP-port IZP that mirrors a first normal output current and outputs it to the sixth differential current comparator COP6, and a second ZP-port IZN that mirrors a second normal output current and outputs it to the sixth differential current comparator COP6.

The first differential current comparator COP1 outputs a first differential current OUT[0] by differentially comparing the first and second normal output currents provided from the first current conveyor CC11 and the first and second normal output currents provided from the second current conveyor CC12 in response to a clock signal.

The second differential current comparator COP2 outputs a second differential current OUT[1] by differentially comparing the first and second normal output currents provided from the third current conveyor CC21 and the first and second normal output currents provided from the fourth current conveyor CC22 in response to a clock signal.

The third differential current comparator COP3 outputs a third differential current OUT[2] by differentially comparing the first and second normal output currents provided from the fifth current conveyor CC31 and the first and second normal output currents provided from the sixth current conveyor CC32 in response to a clock signal.

The fourth differential current comparator COP4 outputs a fourth differential current OUT[3] by differentially comparing the first and second normal output currents provided from the seventh current conveyor CC41 and the first and second normal output currents provided from the eighth current conveyor CC42 in response to a clock signal.

The fifth differential current comparator COP5 outputs a fifth differential current OUT[4] by differentially comparing the first and second normal output currents provided from the ninth current conveyor CC51 and the first and second normal output currents provided from the tenth current conveyor CC52 in response to a clock signal.

The sixth differential current comparator COP6 outputs a sixth differential current OUT[5] by differentially comparing the first and second normal output currents provided from the eleventh current conveyor CC61 and the first and second normal output currents provided from the twelfth current conveyor CC62 in response to a clock signal.

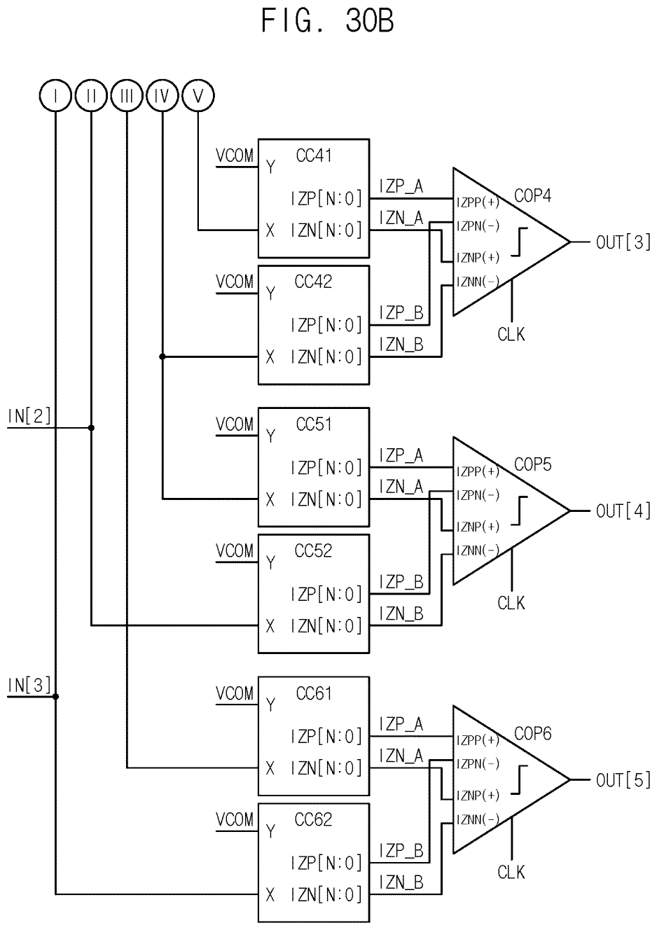

FIG. 31 is a circuit diagram for explaining a first differential current comparator of the current comparator module shown in FIG. 27 or FIG. 30.

Referring to FIG. 31, the first differential current comparator COP1 includes a dynamic latch comparator and generates an output signal based on the difference between the two input currents. That is, the first differential current comparator COP1 generates an output signal by comparing the two input currents input through a first positive input port IZPP and a second positive input port IZPN, based on their difference. Alternatively, the first differential current comparator COP1 generates an output signal by comparing the two input currents input through a first negative input port IZNP and a second negative input port IZNN, based on their difference.

The dynamic latch comparator includes a p-channel MOSFET MP0, a p-channel MOSFET MP1, a p-channel MOSFET MP2, a p-channel MOSFET MP3, an n-channel MOSFET MN0, an n-channel MOSFET MN1, an n-channel MOSFET MN2, an n-channel MOSFET MN3, a p-channel MOSFET MP4, and a p-channel MOSFET MP5.

The p-channel MOSFET MP0 is connected to the first positive input port IZPP through its source, to the clock CLK through its gate, and to the supply voltage VDD through its drain. The p-channel MOSFET MP1 is connected to the first positive input port IZPP through its source, to the source of p-channel MOSFET MP2 through its gate, and to the supply voltage VDD through its drain. The p-channel MOSFET MP2 is connected to the second positive input port IZPN through its source, to the sources of each of the p-channel MOSFET MP0 and p-channel MOSFET MP1 through its gate, and to the supply voltage VDD through its drain. The p-channel MOSFET MP3 is connected to the second positive input port IZPN through its source, to the clock CLK through its gate, and to the supply voltage VDD through its drain.

The n-channel MOSFET MN0 is connected to ground through its source, to the gate of the p-channel MOSFET MP1 through its gate, and to the first negative input port IZNP through its drain. The n-channel MOSFET MN1 is connected to ground through its source, to the gate of the p-channel MOSFET MP2 through its gate, and to the second negative input port IZNN through its drain. The n-channel MOSFET MN2 is connected to the first positive input port IZNP through its source, to the clock CLK through its gate, and to the source of the p-channel MOSFET MP1 through its drain. The n-channel MOSFET MN3 is connected to the second positive input port IZNN through its source, to the clock CLK through its gate, and to the source of the p-channel MOSFET MP2 through its drain. The p-channel MOSFET MP4 is connected to the first positive input port IZNP through its source, to the gate of the p-channel MOSFET MP5 through its gate, and to the source of the p-channel MOSFET MP1 through its drain.

The p-channel MOSFET MP5 is connected to the second positive input port IZNN through its source, to the gate of the p-channel MOSFET MP4 through its gate, and to the source of the p-channel MOSFET MP2 through its drain.

The above description has been made with respect to the first differential current comparator COP1, but since the second differential current comparator COP2 through the sixth differential current comparator COP6 are the same, a detailed description thereof is omitted.

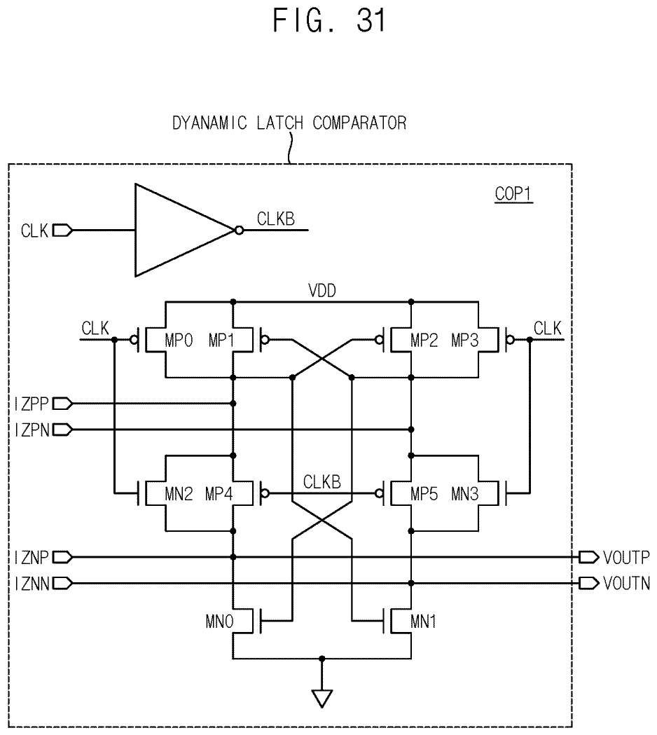

FIG. 32 is a circuit diagram for explaining a first differential current comparator of the current comparator module shown in FIG. 27 or FIG. 30.

Referring to FIG. 32, the first differential current comparator COP1 includes a dynamic latch comparator and an SR latch, and generates an output signal based on the difference between the two input currents. That is, the first differential current comparator COP1 generates an output signal by comparing the two input currents input through its a first positive input port IZPP and its a second positive input port IZPN, based on their difference. Alternatively, the first differential current comparator COP1 generates an output signal by comparing the two input currents input through its a first negative input port IZNP and its a second negative input port IZNN, based on their difference.

The dynamic latch comparator includes a p-channel MOSFET MP0, a p-channel MOSFET MP1, a p-channel MOSFET MP2, a p-channel MOSFET MP3, an n-channel MOSFET MN0, an n-channel MOSFET MN1, an n-channel MOSFET MN2, an n-channel MOSFET MN3, a p-channel MOSFET MP4, and a p-channel MOSFET MP5. The above description of the dynamic latch comparator has been described with reference to FIG. 31, and thus a detailed description thereof will be omitted.

The SR latch includes a first inverter INV1, a second inverter INV2, a first NAND gate NAND1, and a second NAND gate NAND2. Specifically, the first inverter INV1 is connected to the first negative input port IZNP through its input terminal, and the second inverter INV2 is connected to the second negative input port IZNN through its input terminal. The first NAND gate NAND1 is connected to the output terminal of the first inverter INV1 through its first input terminal, and to the output terminal of the second NAND gate NAND2 through its second input terminal. The second NAND gate NAND2 is connected to the output terminal of the first NAND gate NAND1 through its first input terminal, and to the output terminal of the second inverter INV2 through its second input terminal.

In operation, when a current of the first negative input port IZNP is high and a current of the second negative input port IZNN is high, it is the data retention state. When a current of the first negative input port IZNP is low and a current of the second negative input port IZNN is low, it is the data destruction state. When a current of the first negative input port IZNP is low and a current of the second negative input port IZNN is high, it is the data set state. When a current of the first negative input port IZNP is high and a current of the second negative input port IZNN is low, it is in the data reset state.

On the other hand, an equalization used in the present invention improves the quality of the received signal by controlling the reception sensitivity of the RCV block. This is achieved by varying the bias current of the comparator or controlling the data comparison timing to reduce Inter-symbol Interference (“ISI”) that occurs in the PAM4 signal, thereby enhancing the quality of the received signal.

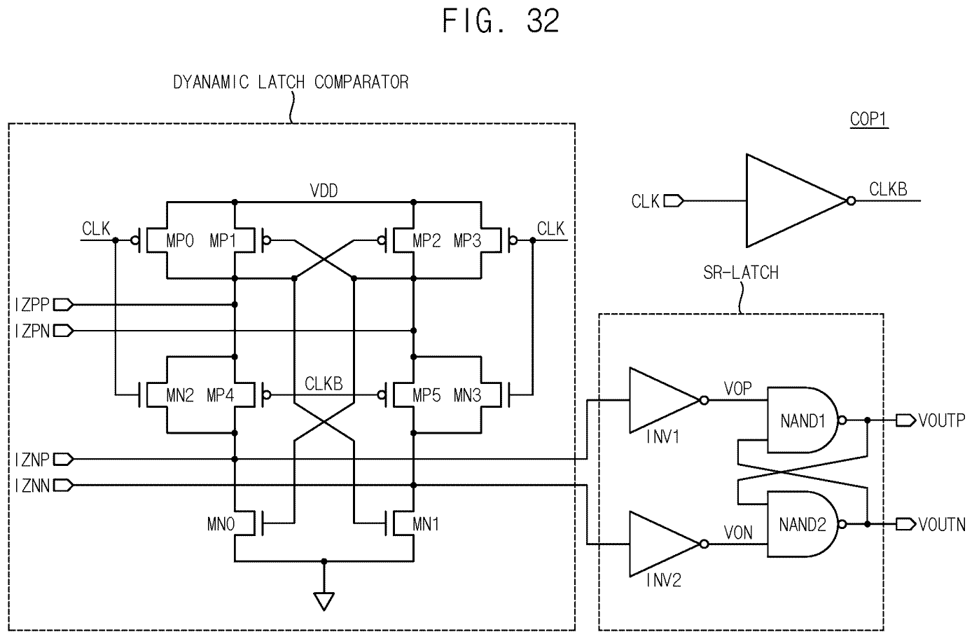

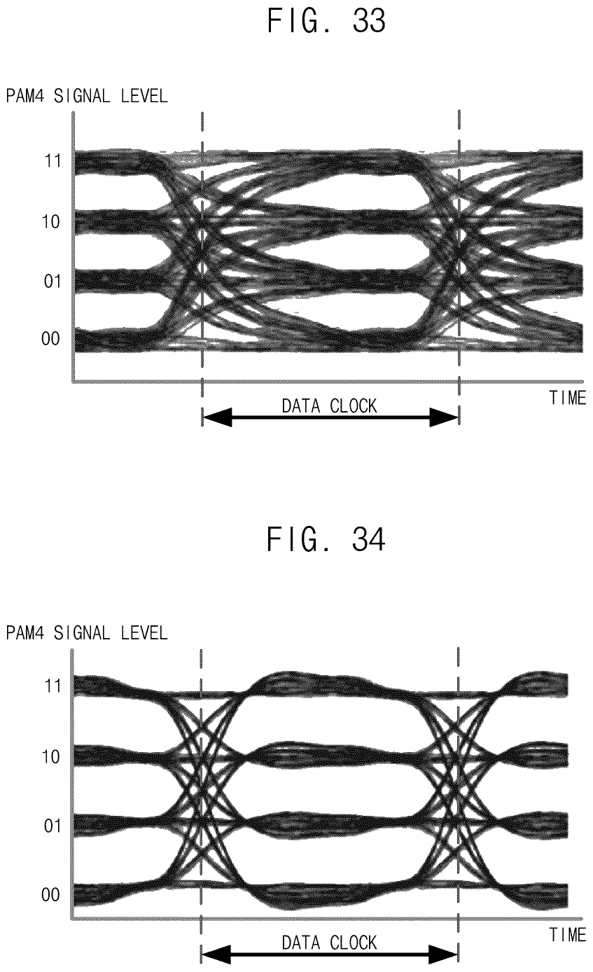

FIG. 33, which will be described later, illustrates the eye-diagram of a PAM4 signal with vulnerable characteristics, and FIG. 34, which will be described later, illustrates the eye-diagram of a PAM4 signal with improved characteristics through the use of a pre-emphasis circuit PEC.

FIG. 33 illustrates an eye-diagram of the PAM4 signal received from the PAM4 signal basic communication system according to a comparative example.

Referring to FIG. 33, it can be observed that the eye pattern exhibits a relatively small eye opening (i.e., the white central region) and a jitter phenomenon, in which the period of the data clock is not constant. The reduction in the eye opening area and the increase in jitter are attributable to the driving characteristics of the high-speed PHY unit and the signal transmission characteristics of the transmission line.

The presence of a narrow eye pattern and significant jitter characteristics increases the likelihood of transmission errors on the transmission line, thereby resulting in an increased bit error rate (BER). Accordingly, the use of a pre-emphasis function is required as a means to mitigate such issues and improve signal integrity.

FIG. 34 illustrates an eye-diagram of the PAM4 signal received from the PAM4 signal basic communication system according to the present invention. In particular, when pre-emphasis is performed on the DRV block side and equalization is performed on the RCV block side, the eye pattern of the received PAM4 signal is shown.

Referring to FIG. 34, it can be seen that the eye pattern exhibits a larger eye opening (i.e., the white central region), and the period of the data clock remains relatively constant, indicating a reduction in jitter.

The data transmission speed may be enhanced, or the bit error rate (BER) may be improved, by performing pre-emphasis based on an understanding of the signal transmission characteristics of a high-speed transmission line. Accordingly, high-speed communication systems generally include both a pre-emphasis circuit and an equalization circuit, and such circuits have also been applied in the present invention in consideration of the characteristics of the transmission line and the associated circuitry.

Hereinafter, an embodiment of the present invention will be described in which a PAM4 signal is transmitted and received through a link unit comprising four transmission lines, and a current conveyor is employed in both the DRV block and the RCV block.

According to an embodiment of the present invention, a system is provided for transmitting, receiving, and decoding data by performing encoding in which 24 symbols are mapped in a one-to-one correspondence with data to be transmitted.

According to an embodiment of the present invention, it is not necessary to control the DC level of the link unit (transmission line), as is required in the parallel transmission method of the comparative example, and the proposed method enables transmission of a greater number of symbols compared to conventional methods.

Table 6 illustrates the number of transmission bits per transmission line corresponding to each transmission method, including the parallel transmission method using NRZ signaling and the transmission method using PAM4 signaling, as presented in the comparative example.

TABLE 6

| | Total number | Traditional parallel | | Transmission method | |
|---|---|---|---|---|---|
| | of | transmission method (NRZ) | | (PAM4) of this invention | |
| Number of | transmission | Number of | Number of Link | Number of | Number of Link |
| Link Units | lines on Link | symbols | Transfer Bits | symbols | Transfer Bits |
| 1 | 4 | 16 | 4 | 24 | 4.585 |
| 2 | 8 | 256 | 8 | 576 | 9.170 |
| 4 | 16 | 65536 | 16 | 331776 | 18.340 |
| 8 | 32 | 4294967296 | 32 | 1.10075E+11 | 36.680 |
| 16 | 64 | 1.84467E+19 | 64 | 1.21166E+22 | 73.359 |
| 32 | 128 | 3.40282E+38 | 128 | 1.46811E+44 | 146.719 |

Referring to Table 6, when four transmission lines are used as a basic unit for data transmission, the total number of symbols achievable using the parallel transmission method (i.e., the NRZ method) in the comparative example is 2\hat{ }4=16. Accordingly, 16 symbols can be transmitted simultaneously, corresponding to 4 bits of data transmitted per 4 transmission lines at a time. In contrast, the present invention transmits and receives data by using 24 distinct differential PAM4 symbols selected from the 256 possible symbols achievable with 4 transmission lines. Thus, 24 different symbols are transmitted per link unit consisting of 4 transmission lines, which corresponds to approximately 4.585 bits of data transmitted per 4 transmission lines at a time.

Meanwhile, when 16 link units are used (i.e., a link is composed of 64 transmission lines), the number of symbols that can be transmitted simultaneously using the NRZ scheme of the comparative example is approximately 2\hat{ }64=1.84467×10\hat{ }19 (equivalent to 16\hat{ }16). In contrast, under the PAM4 scheme of the present invention, the number of transmittable symbols is approximately 24\hat{ }16=1.21166×10\hat{ }22. Accordingly, for the same number of transmission lines, the PAM4 scheme of the present invention enables the transmission of approximately 656.8 times more symbols than the NRZ scheme of the comparative example.

Furthermore, in order to transmit 64-bit data at once, the NRZ method of the comparative example requires a communication link composed of 64 transmission lines. In contrast, the PAM4 method of the present invention can achieve the same 64-bit data transmission using only 56 transmission lines. Accordingly, the PAM4 scheme enables a reduction in the number of required transmission lines compared to the NRZ scheme, thereby offering advantages in terms of hardware complexity, layout efficiency, and overall system cost.

In the case of the NRZ method of the comparative example, the number of symbols that can be transmitted at once through a link composed of 64 transmission lines (i.e., 16 link units) is 2\hat{ }64, which equals 16\hat{ }16=18,446,744,073,709,551,616.

On the other hand, in the case of the PAM4 method of the present invention, the number of symbols that can be transmitted at once through a link composed of 56 transmission lines (i.e., 14 link units) is 24\hat{ }14, which equals 21,035,720,123,168,587,776.

In summary, according to the PAM4 method of the present invention, the number of symbols that can be transmitted through a link with 56 transmission lines exceeds that of the NRZ method of the comparative example, which requires 64 transmission lines to transmit a similar number of symbols.

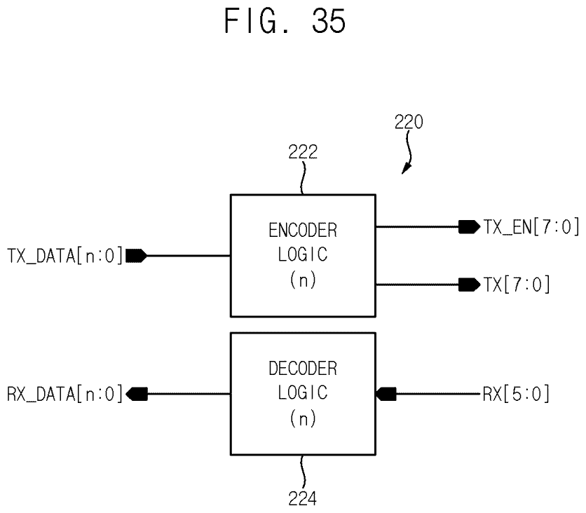

FIG. 35 is a block diagram for explaining a first encoding/decoding unit shown in FIG. 11.

Referring to FIG. 11 and FIG. 35, the first encoding/decoding unit 220 includes an encoder logic 222 and a decoder logic 224.

During signal transmission, the encoder logic 222 receives data TX_DATA[n:0] to be transmitted from a communication entity (such as a processor unit or a memory device) and generates a TX signal TX[7:0] and a TX enable signal TX[7:0] to drive the first PHY unit 210 using a symbol that matches the data 1:1 to the data. The TX signal TX[7:0] and the TX enable signal TX_EN[7:0] generated by the encoder logic 222 are converted into a form of current through a current conveyor and then output to the link unit through each I/O pad.

Upon data reception, the decoder logic 224 receives six PAM4 comparison signals RX[5:0] output from the second PHY unit 310, reconstructs the original 24 symbols from these signals, and then converts the restored symbols into corresponding digital values RX_DATA[n:0].

An example of the symbol encoding and decoding method is illustrated in Table 4 above.

Referring again to Table 4, the definitions of 24 symbols defined by graph coloring theory, the allocation of decimal and 24-binary digits for the corresponding symbol, and the signal value (PAM4 value/value for each transmission line) of the corresponding symbol are expressed. In addition, the comparison values of the six distinct receiving comparators are shown in RX[0] to RX[5], and the results of the six comparators are expressed in a decimal value RX[0:5] with 6 bits.

When each link unit having four transmission lines is driven by a PAM4 signal, a total of 256 possible signal combinations exist (4\hat{ }4=256). However, as described above, the sum of the PAM4 signals is “O” using the graph coloring theory, and the number of cases in which the results of the six comparators have a unique value that does not overlap is 24. In the present embodiment, only 24 symbols are used for communication.

The decimal values ranging from 0 to 23 may be respectively mapped to a set of 24-binary digits symbols as defined below.
[0,1,2,3,4,5,6,7,8,9,A,B,C,D,E,F,G,H,I,J,K,L,M,N]

That is, when decimal data is expressed as 24-binary digits, numbers greater than decimal 10 may be assigned to 24-binary digits in alphabetical order. In the present invention, this assignment method is used as an illustrative example; however, any symbolic notation scheme may be applied, provided that it clearly distinguishes all 24 unique values.

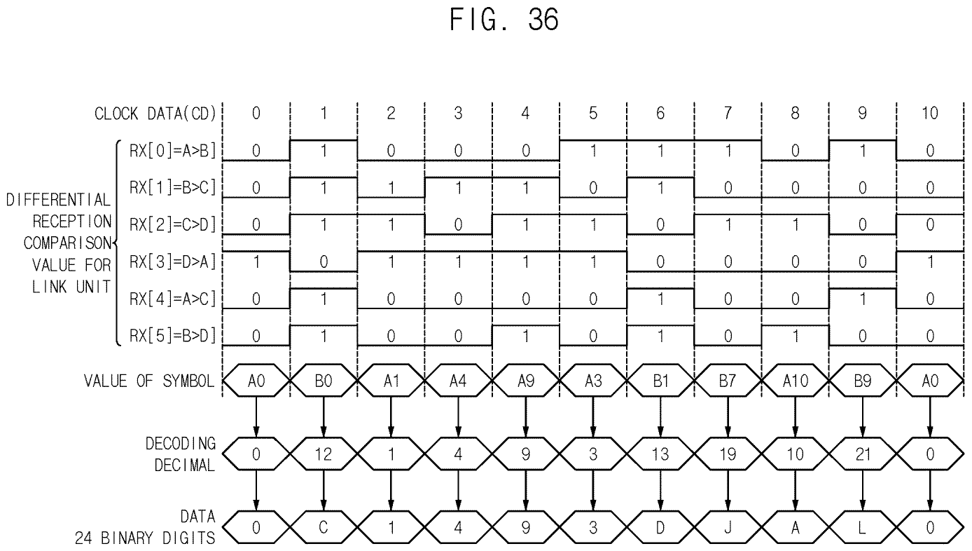

FIG. 36 is a diagram for explaining symbol restoration by the first communication unit or the second communication unit shown in FIG. 11.

Referring to FIG. 11 and FIG. 36, when 24-binary digits [0, C, 1, 4, 9, 3, D, J, A, L, 0] (i.e., decimal data [0, 12, 1, 4, 9, 13, 19, 10, 21, 0]) is transmitted from the first communication unit 200 through the link unit 100, a process is illustrated in which the second communication unit 300 receives the signals through the link unit 100, maps the received signals to corresponding symbols, and decodes the transmitted data.

Transmission data and reception data are transmitted and received at a predetermined clock data (CD) rate.

In FIG. 36, the data restoration process performed by the receiver of the second communication unit 300 is illustrated. Since the encoding process performed by the transmitter proceeds in the reverse order of the restoration process performed by the receiver, a separate detailed description of the encoding process is omitted in this embodiment.

When data with CD=0 is received, the value of RX[0:5] corresponds to the binary value [00100], which matches the A0 symbol shown in Table 4 above. The A0 symbol represents the decimal value 0, and the corresponding 24-binary digits also represent 0. This process is defined as decoding, representing the case where decimal 0 or the 24-binary digits 0 is received.

When data with CD=1 is received, the value of RX[0:5] corresponds to the binary value [111011], which corresponds to the BO symbol shown in Table 4 above. The BO symbol represents the decimal number 12, and the corresponding 24-binary digits represent C.

When the remaining data corresponding to CD=2 to CD=10 is received, the data is received and decoded in the same manner as described above, restoring the transmitted data value based on the differences between the received PAM4 signals.

As described above, the present invention is capable of solving various problems that occur in high-speed parallel transmission systems. Although it is also possible to implement data transmission by configuring multiple existing high-speed serial transmission schemes (e.g., USB, SATA, PCI Express, etc.) in parallel, the present invention is clearly distinguished from such conventional schemes in the following aspects.

In conventional high-speed serial signal transmission methods, a “channel” is defined as a single communication unit, and data transmission is implemented by configuring multiple channels in parallel. However, such methods have disadvantages in that they require complex hardware and high power consumption due to the need for individual channel configurations. In particular, a Serializer/Deserializer (SerDes) is essential in high-speed serial transmission, and additional clock generation circuits and a phase-locked loop (PLL) are required to convert parallel data into serial data and vice versa. This not only increases system complexity and power consumption but also results in inefficiency in environments where transmission lines are short and easy to manage.

On the other hand, the present invention provides improved performance over conventional non-return-to-zero (NRZ) methods by applying a PAM (Pulse Amplitude Modulation) signal to high-speed parallel transmission lines (e.g., T-link, TSV-link) using differential signaling. In the present invention, a signal to be transmitted is converted into a PAM signal (e.g., PAM3, PAM4, PAM5, PAM6, etc.), allowing more data to be transmitted over a smaller number of transmission lines. This approach significantly reduces hardware complexity and power consumption compared to conventional parallel transmission systems, while enhancing the overall efficiency of high-speed parallel data transmission.

Furthermore, the data communication system according to the present invention is designed to maintain a constant electrical signal on each transmission line, thereby preventing significant variations in energy consumption caused by changes in data patterns. In contrast, in a conventional high-speed parallel communication system comprising 1024 transmission lines, where each transmission line consumes 1 pJ per bit for data transmission, the energy consumption becomes theoretically 0 pJ when the previous and current data are identical. However, when all previous data are ‘0’ and all current data are ‘1’, the energy charged from the I/O power supply (VDDQ) becomes 1024 pJ. Conversely, when all previous data are ‘1’ and all current data are ‘0’, the energy discharged to the I/O ground (VSSQ) also becomes 1024 pJ. As a result, the ratio between the minimum and maximum energy consumption becomes extreme—in theory, approaching infinity. Such abrupt variation imposes a significant burden on the power delivery system and may lead to signal quality degradation, including deterioration of signal-to-noise ratio (SNR) and bit error rate (BER).

However, since the present invention is designed to maintain substantially constant power consumption regardless of data pattern, the ratio of maximum energy to minimum energy theoretically approaches 1:1. This configuration simplifies the power supply system and enhances the stability of data communication. Furthermore, the power consumption per bit is lower than that of conventional technologies, thereby contributing to reduced overall system power consumption and decreased heat generation.

Additionally, during the encoding and decoding of transmission data into PAM-based differential signals, the present invention is designed such that the sum of the electrical signals applied to the transmission lines (e.g., 3, 4, 5, 6, etc.) within each unit (e.g., T-link, TSV-link) constituting the transmission link is always zero. This approach significantly reduces the difference between the maximum peak power and the average power consumption (RMS power) observed in conventional parallel signal transmission methods, thereby minimizing overall power consumption.

In addition, the present invention not only reduces power consumption at the overall system level in the data transmission system, but also simplifies the design of power and signal lines between the power supply system and the PCB, silicon interposer, or glass interposer, thereby contributing to a reduction in manufacturing costs.

Accordingly, the present invention improves energy consumption imbalance, signal-to-noise ratio (SNR), and bit error rate (BER) issues compared to conventional parallel communication methods, thereby enabling high-speed data transmission using fewer transmission lines and reduced power consumption.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of selecting a symbol, the method comprising:
inputting a first condition, a second condition, a third condition, and a fourth condition to be identified in a program designed to select a symbol, wherein:
the first condition is that the sum of the difference values based on the common voltage of all transmission lines equals 0V;
the second condition is that adjacent transmission lines must have different signal levels;
the third condition is that the elements must convert into differential signals through a comparison of signal levels between adjacent transmission lines and must have different differential signals; and
the fourth condition is that the elements must convert into differential signals through a comparison of signal levels between non-adjacent transmission lines and must have different differential signals;
inputting the number of transmission lines, the number of signal levels, and determining the type of signal levels;
initializing a candidate list and a resultant list;
inputting the number of transmission lines, the number of signal levels, and the number of all possible configurations of the transmission lines into the candidate list, taking into account the types of signal levels;
extracting one element from the candidate list;
inputting the extracted element into the resultant list when the extracted element satisfies the first condition and then repeating the extracting one element;
inputting the extracted element into the resultant list when the extracted element satisfies the second condition and then repeating the extracting one element;
inputting the extracted element into the resultant list when the extracted element satisfies the third condition and then repeating the extracting one element;
inputting the extracted element into the resultant list when the extracted element satisfies the fourth condition and then repeating the extracting one element; and
outputting the resultant list when there are no remaining elements in the candidate list.

2. The method of claim 1, wherein the element means each of the number of cases according to the number of transmission lines and the number of signal levels.

3. A data communication system comprising:
a link unit comprising a plurality of transmission lines;
a first communication unit connected to one side of the link unit to transmit and receive pulse amplitude modulation (PAM) signals; and
a second communication unit connected to another side of the link unit to transmit and receive the PAM signals,
wherein the number of PAM signal levels driving the transmission line is greater than or equal to the number of transmission lines, the sum of PAM values of each transmission line is “0”, and signal pairs with different signal levels of each transmission line are assigned to a vertex and a line segment of an inference graph diagram using graph coloring theory, and are defined as symbols according to a determined relationship, and
wherein each of the first communication unit and the second communication unit encodes and transmits transmission data to fit a corresponding symbol, and decodes and restores the received data.

4. The data communication system of claim 3, wherein each of the first communication unit and the second communication unit comprises:
a PHY unit comprising one or more DRV blocks converting a voltage-level TX signal input from an external side into current and output the converted current to the transmission line through an I/O pad, and one or more RCV blocks receiving PAM signals transmitted through the link unit, and being connected to one side of the link unit to transmit and receive the PAM signal; and
an encoding/decoding unit connected to another side of the PHY unit.

5. The data communication system of claim 4, wherein the DRV block comprises:
a first TX buffer buffering the first TX signal;
a first TX resistor having one end connected to an output terminal of the first TX buffer and another end connected to the I/O pad;
a second TX buffer buffering the second TX signal; and
a second TX resistor having one end connected to an output terminal of the second TX buffer and another end connected to the I/O pad.

6. The data communication system of claim 4, wherein the DRV block comprises:
a PAM encoding unit encoding the TX signal according to the TX enable signal;
a first buffer comprising a front-end inverter inverting the TX signal when enabled by the TX enable signal, and a rear-end inverter connected to the output of the front-end inverter, which inverts the signal inverted by the front-end inverter when enabled by the TX enable signal; and
a voltage-to-current converter converting the PAM signal buffered by the first buffer into current.

7. The data communication system of claim 4, wherein the DRV block comprises:
a first TX buffer buffering a first TX signal;
a first TX resistor having one end connected to the output side of the first TX buffer;
a second TX buffer buffering a second TX signal;
a second TX resistor having one end connected to the output side of the second TX buffer; and
a current conveyor comprising an X-port connected to the common node of the first TX resistor and the second TX resistor, a Y-port to which the common-mode voltage on the transmission line is applied, and a ZP-port connected to the I/O pad.

8. The data communication system of claim 4, wherein the DRV block comprises:
a first TX buffer buffering a first TX signal;
a first TX resistor having one end connected to the output side of the first TX buffer;
a second TX buffer buffering a second TX signal;
a second TX resistor having one end connected to the output side of the second TX buffer;
a current conveyor comprising an X-port connected to the common node of the first TX resistor and the second TX resistor, a Y-port to which the common-mode voltage on the transmission line is applied, and a ZP-port connected to the I/O pad; and
a pre-emphasis circuit comprising a pre-emphasis buffer, a variable resistor, and a variable capacitor, and is enabled by a TX enable signal, wherein the pre-emphasis circuit temporarily increases or decreases the strength of the TX signal applied to the X-port of the current conveyor.

9. The data communication system of claim 4, wherein the RCV block comprises:
a voltage generating part comprising a plurality of RC parallel circuits to convert the current of the PAM signal provided through the transmission line into a voltage; and
a voltage comparator module comprising a plurality of differential voltage comparators, which differentially compare the PAM signals converted into voltage by the voltage generating part.

10. The data communication system of claim 9, wherein in each of the RC parallel circuits, the R value is a value of the intended circuit component between 10Ω and 300Ω, and the C value is the value of an unintended parasitic capacitance component or an intended correction capacitance component.

11. The data communication system of claim 9, wherein each of the differential voltage comparators comprises differential voltage comparators detecting the difference in the input voltage of the gate by applying a current bias.

12. The data communication system of claim 4, wherein the RCV block comprises:
a voltage generating part comprising a plurality of current conveyors and a plurality of RC parallel circuits disposed at the output side of the current conveyors, and converting the current of the PAM signal provided through the transmission line into a voltage; and
a voltage comparator module comprising a plurality of differential voltage comparators, which differentially compare the PAM signals converted into voltage by the voltage generating part.

13. The data communication system of claim 12, wherein the voltage comparator module comprises:
a first differential voltage comparator outputting a first differential voltage by differentially comparing a first voltage and a second voltage provided by the voltage generating part;
a second differential voltage comparator outputting a second differential voltage by comparing the second voltage and a third voltage provided by the voltage generating part;
a third differential voltage comparator outputting a third differential voltage by comparing the third voltage and a fourth voltage provided by the voltage generating part;
a fourth differential voltage comparator outputting a fourth differential voltage by comparing the first voltage and the fourth voltage provided by the voltage generating part;
a fifth differential voltage comparator outputting a fifth differential voltage by comparing the first voltage and the third voltage provided by the voltage generating part; and
a sixth differential voltage comparator outputting a sixth differential voltage by comparing the second voltage and the fourth voltage provided by the voltage generating part.

14. The data communication system of claim 13, wherein each of the first to sixth differential voltage comparators operates in response to a clock.

15. The data communication system of claim 14, wherein each of the first to sixth differential voltage comparators comprises:
a differential ARM (Analog Re-generative Memory) latch voltage comparator detecting the difference in the input voltage of the gate using a comparison clock.

16. The data communication system of claim 15, wherein the differential ARM (Analog Re-generative Memory) latch voltage comparator comprises:
a differential voltage comparator comparing two input signals and determines the output signal by amplifying the difference between VIN (+) and VIN (−), and generating the output signal based on the amplified difference; and
an SR latch storing the output state of the differential voltage comparator and maintains it for a predetermined time.

17. The data communication system of claim 4, wherein the RCV block comprises:
a voltage generating part comprising a plurality of current conveyors and a plurality of R circuits arranged at the output side of the current conveyors, and converting the current of the PAM signal provided through the transmission line into a voltage; and
a voltage comparator module comprising a plurality of differential voltage comparators, and differentially comparing the PAM signals converted into voltage by the voltage generating part.

18. The data communication system of claim 17, wherein the voltage generating part further comprises a variable resistor having one end connected to the transmission line and another end connected to the current conveyor.

19. The data communication system of claim 4, wherein each of the first communication unit and the second communication unit further comprises:
a pre-encoder that is connected to another side of the encoding/decoding unit on one side, receives data to be transmitted from a processor unit or memory device during signal transmission, and performs pre-encoding processing on the received data.

20. The data communication system of claim 4, wherein each of the first communication unit and the second communication unit further comprises:
a post decoder that is connected to another side of the encoding/decoding unit on one side, and performs post-decoding processing on the data received during data reception.
